(19) United States
(12) Patent Application Publication
(10) Pub. No.: US 2025/0287099 A1
(43) Pub. Date: Sep. 11, 2025

(54) PORTABLE INFORMATION TERMINAL AND IMAGE MANAGEMENT METHOD

(71) Applicant: KEYENCE CORPORATION, Osaka (JP)

(72) Inventor: Naoki Goto, Osaka-shi (JP)

(73) Assignee: KEYENCE CORPORATION, Osaka (JP)

(21) Appl. No.: 19/064,072

(22) Filed: Feb. 26, 2025

(30) Foreign Application Priority Data
Mar. 6, 2024 (JP) 2024-034090

(51) Int. Cl. H04N 23/667; G06F 1/16; H04M 1/72463; H04N 1/21

(52) U.S. Cl. CPC H04N 23/667; G06F 1/1686; H04M 1/72463; H04N 1/2129; H04N 1/2137

(57) ABSTRACT

The problem is to prevent external leakage of images captured by a camera when using a camera mounted on a portable information terminal for imaging of image processing targets. The solution means that the security mode deletes the code image Ic generated by the rear camera 33 from the volatile memory 61 without storing it in the non-volatile memory 62 (step S604 in FIG. 6D). In the security mode, instead of this operation, a step of forcibly deleting the code image Ic stored in the non-volatile memory 62 from the non-volatile memory 62 may be executed. With this configuration, by selecting the security mode, the code image Ic generated by the rear camera 33 is deleted, so there is no leakage to the outside.

### CROSS-REFERENCE TO RELATED APPLICATIONS

The present application claims foreign priority based on Japanese Patent Application No. 2024-034090, filed Mar. 6, 2024, the contents of which are incorporated herein by reference.

### BACKGROUND OF THE INVENTION

### 1. Technical Field

The present disclosure relates to a technology for reading codes attached to a workpiece.

### 2. Description of the Related Art

Japanese Patent Publication No. 2022-144178 discloses an information reading device that reads codes such as barcodes and QR codes (registered trademark).

This information reading device acquires images through a camera unit provided at the upper end of the housing and reads the codes by decoding the codes contained in the images.

There is a need to easily perform reading of codes as described above and image processing such as OCR (Optical Character Recognition/Reader) using portable information terminals represented by smartphones. In response to this, it is possible to meet such needs by using the camera mounted on the portable information terminal for capturing images of the image processing target. However, this camera can also be used for taking photographs of people and landscapes, and the images captured by the camera may contain information other than the image processing target. Therefore, in areas dealing with confidential information, it has been difficult to use the camera mounted on such portable information terminals for capturing images of the image processing target.

The present disclosure has been made in consideration of the above problems, and aims to provide a technology that can prevent external leakage of images captured by a camera used for imaging of image processing targets mounted on a portable information terminal.

### SUMMARY OF THE INVENTION

The portable information terminal according to the present disclosure includes a camera that captures a workpiece and generates a captured image, a reading unit that executes image processing based on the captured image to acquire information contained in the workpiece, a first memory unit that is a volatile memory unit and temporarily stores the captured image, a second memory unit that is a non-volatile memory unit and stores settings of the image processing and is capable of storing the captured image, a control unit that causes the camera to generate the captured image and store the captured image in the first memory unit, and causes the reading unit to execute the image processing based on the captured image in the first memory, a mode selection unit that selects any of a plurality of modes including a first mode where the captured image is stored in the second memory unit and a second mode where the captured image is deleted from the first memory unit without the captured image being not stored in the second memory unit or the captured image is forcibly deleted from the second memory unit after being stored in the second memory.

The image management method according to the present disclosure is an image management method for managing a first memory unit or a second memory unit of a captured image generated by a camera that captures a workpiece, comprising: a step of selecting any of a plurality of modes including a first mode where the captured image generated by the camera is stored in the second memory unit, and a second mode where the captured image is deleted from the first memory unit without being stored in the second memory unit, or the captured image is forcibly deleted from the second memory unit after being stored in the second memory unit; and a step of controlling the camera to generate the captured image and storing the captured image in the first memory unit, and executing image processing based on the captured image in the first memory unit to acquire information included in the workpiece, wherein the first memory unit is a volatile memory unit that temporarily stores the captured image, and the second memory unit is a non-volatile memory unit that is capable of storing the captured image and stores settings of the image processing.

In the present disclosure (portable information terminal and image management method) configured as such, by selecting the second mode, the captured image generated by the camera is deleted, preventing the captured image from leaking externally. Thus, when using the camera mounted on the portable information terminal for capturing the image processing target, it becomes possible to prevent external leakage of the images captured by the camera.

According to the above disclosure, it is possible to prevent external leakage of images captured by the camera when using the camera mounted on a portable information terminal for imaging of image processing targets.

### BRIEF DESCRIPTION OF THE DRAWINGS

FIG. 1A is a front view showing the external configuration of the portable information terminal according to the present disclosure.

FIG. 1B is a rear view showing the external configuration of the portable information terminal of FIG. 1A.

FIG. 1C is a side view showing the external configuration of the portable information terminal of FIG. 1A.

FIG. 1D is a partial perspective view showing the external configuration of the portable information terminal of FIG. 1A.

FIG. 1E is a rear view showing the layout in the rear camera unit of the portable information terminal.

FIG. 1F is a side view schematically showing the operation of the rear camera unit of the portable information terminal of FIG. 1A.

FIG. 2A is a block diagram showing the electrical configuration of the portable information terminal equipped with FIG. 1A.

FIG. 2B is a block diagram showing the electrical configuration of the portable information terminal equipped with FIG. 1A.

FIG. 2C is a block diagram showing the electrical configuration of the portable information terminal equipped with FIG. 1A.

FIG. 3A is a diagram showing an example of a user application screen.

FIG. 3B is a diagram showing an example of an image view window.

FIG. 3C is a diagram showing an example of an image view window.

FIG. 3D is a diagram showing an example of the display mode between the user application screen and the image view window.

FIG. 4A is a diagram schematically showing the alignment by the virtual aimer.

FIG. 4B is a diagram schematically showing the alignment by the aimer light.

FIG. 5A is a flowchart showing an example of a multiple code reading mode executed by the service unit.

FIG. 5B is a flowchart showing an example of the necessity determination of registration executed by the user application according to the multiple code reading mode of FIG. 5A.

FIG. 5C is a diagram schematically showing the operation executed in the multiple code reading mode of FIG. 5A.

FIG. 6A is a flowchart showing an example of code reading executed by the portable information terminal.

FIG. 6B is a flowchart showing an example of a single code reading mode executed in the code reading of FIG. 6A.

FIG. 6C is a flowchart showing an example of a multiple code reading mode executed in the operation of FIG. 6A.

FIG. 6D is a flowchart showing an example of data saving process executed in the code reading of FIG. 6A.

FIG. 6E is a flowchart showing an example of screenshot control.

FIG. 7A is a flowchart showing an example of code reading condition control.

FIG. 7B is a diagram schematically showing the operation executed in the code reading condition control of FIG. 7A.

FIG. 7C is a diagram schematically showing the operation executed in the code reading condition control of FIG. 7A.

FIG. 7D is a diagram schematically showing the operation executed in the code reading condition control of FIG. 7A.

FIG. 8A is a rear view showing an example of an attachment.

FIG. 8B is a rear view showing an example of an attachment.

FIG. 8C is a rear view showing an example of an attachment.

FIG. 8D is a rear view showing an example of an attachment.

FIG. 8E is a rear view showing an example of an attachment.

FIG. 9 is a block diagram showing the electrical configuration of the portable information terminal that determines the type of attachment.

FIG. 10 is a flowchart showing a modified example of the method for setting the security mode.

FIG. 11A is a rear view showing a modified example of the layout in the rear camera unit.

FIG. 11B is a rear view showing a modified example of the layout in the rear camera unit.

FIG. 11C is a rear view showing a modified example of the layout in the rear camera unit.

FIG. 11D is a rear view showing a modified example of the layout in the rear camera unit.

FIG. 12A is a diagram showing the first modified example of the display mode between the user application screen and the image view window.

FIG. 12B is a diagram showing the first modified example of the display mode between the user application screen and the image view window.

FIG. 13A is a diagram showing the second modified example of the display mode between the user application screen and the image view window.

FIG. 13B is a diagram showing the second modified example of the display mode between the user application screen and the image view window.

FIG. 14A is a flowchart showing the first modified example of the display control of the image view window.

FIG. 14B is a flowchart showing the second modified example of the display control of the image view window.

FIG. 15 is a flowchart showing an example of registration management of read data by the user application.

### DETAILED DESCRIPTION

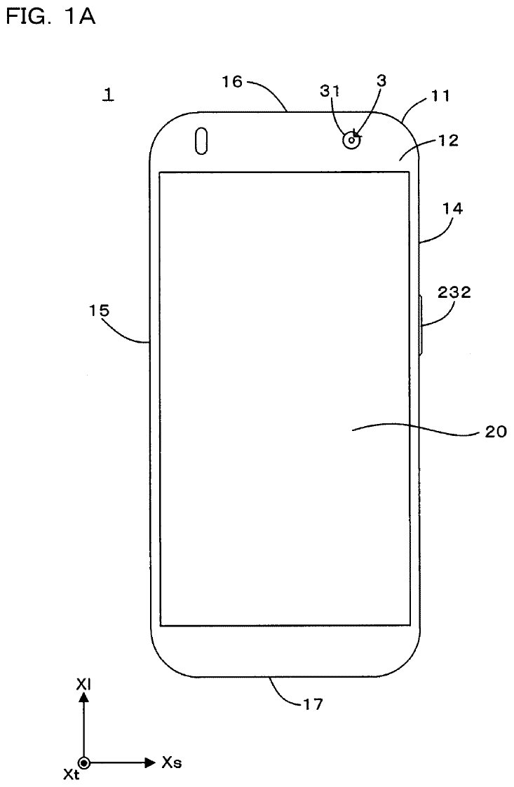

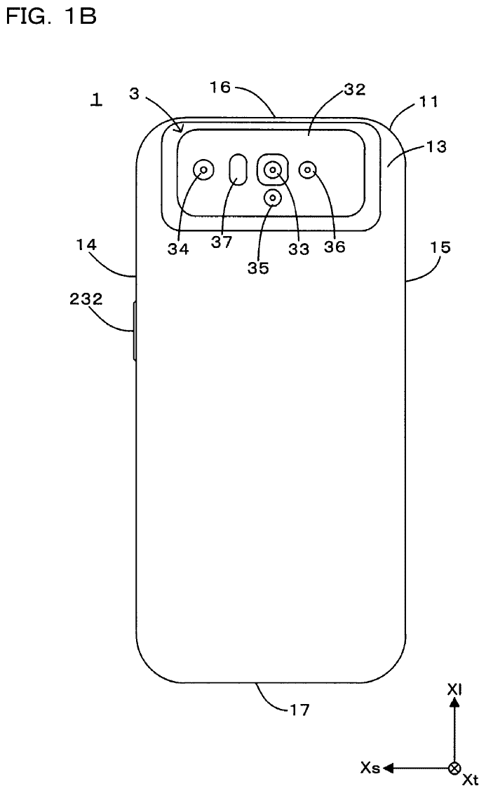

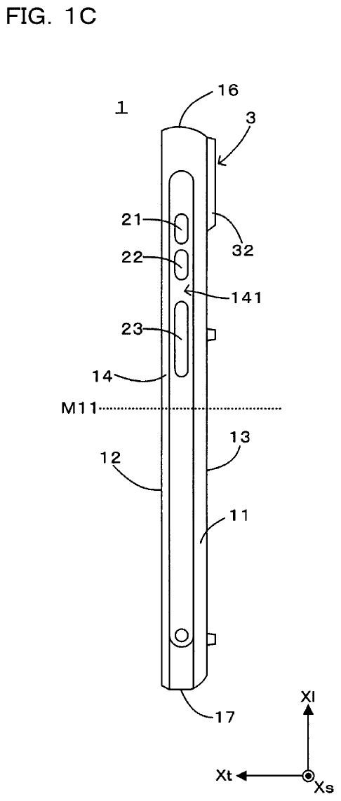

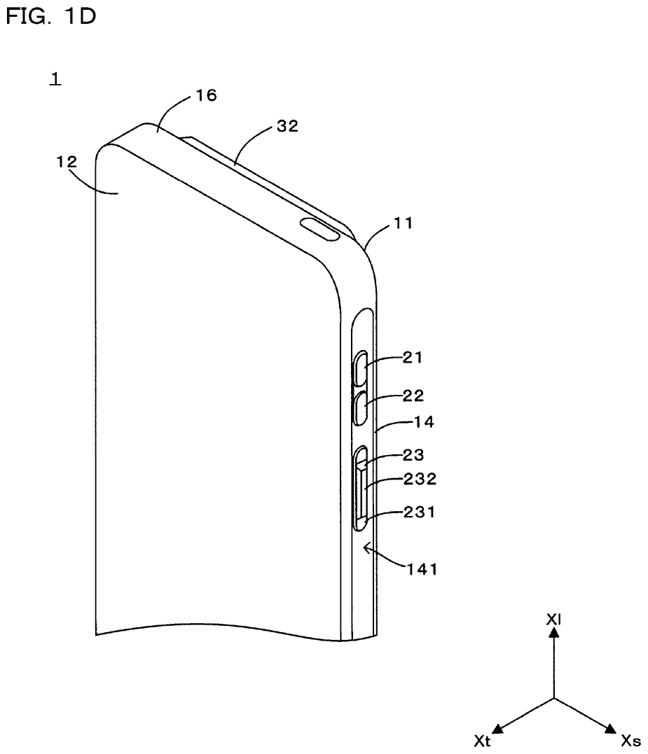

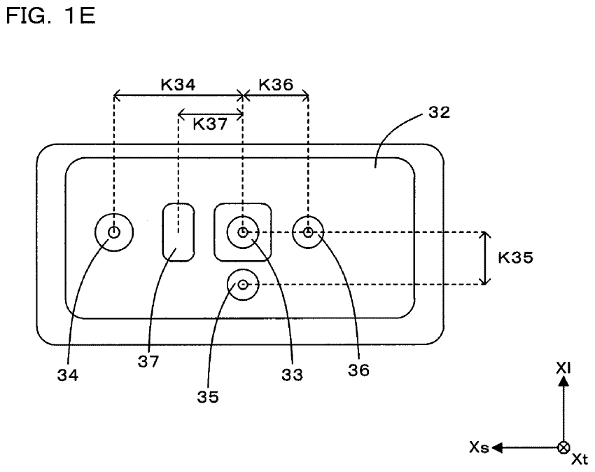

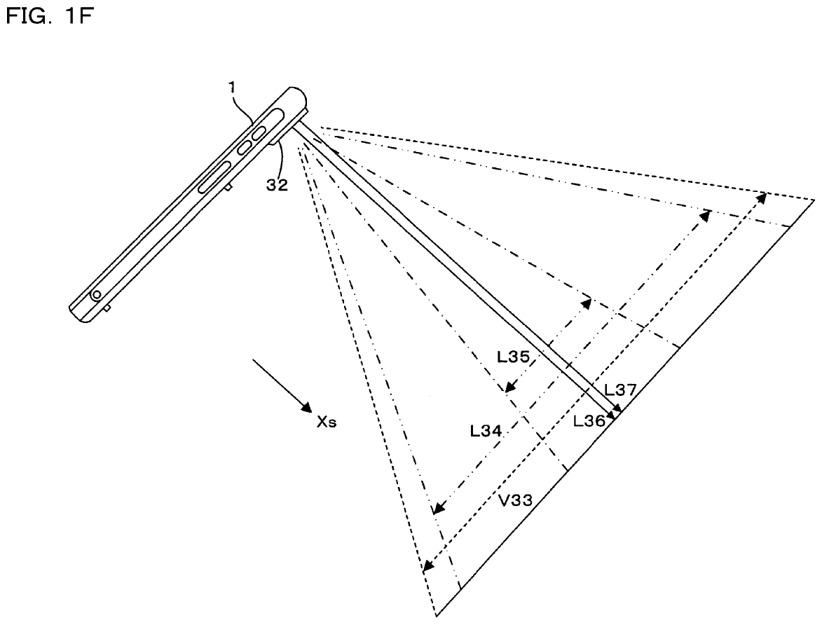

FIG. 1A is a front view showing the external configuration of a portable information terminal according to the present disclosure, FIG. 1B is a rear view showing the external configuration of the portable information terminal in FIG. 1A, FIG. 1C is a side view showing the external configuration of the portable information terminal in FIG. 1A, FIG. 1D is a partial perspective view showing the external configuration of the portable information terminal in FIG. 1A, FIG. 1E is a rear view showing the layout of the rear camera unit of the portable information terminal, and FIG. 1F is a side view schematically showing the operation of the rear camera unit of the portable information terminal in FIG. 1A. In this embodiment, the short side direction Xs, long side direction Xl, and thickness direction Xt of the portable information terminal 1, which are mutually orthogonal, are appropriately indicated.

The portable information terminal 1 has a rectangular housing 11 with rounded corners when viewed from the front or back in the thickness direction Xt. The housing 11 is short in the short side direction Xs and long in the long side direction Xl; in other words, the size of the housing 11 in the short side direction Xs is shorter compared to the size of the housing 11 in the long side direction Xl. The housing 11 includes a front surface 12 provided on the front side in the thickness direction Xt, a back surface 13 provided on the rear side in the thickness direction Xt, a right side surface 14 provided on the right side when viewed from the front, a left side surface 15 provided on the left side when viewed from the front, a top surface 16 provided on the upper side when viewed from the front, and a bottom surface 17 provided on the lower side when viewed from the front. The front surface 12 and the back surface 13 are parallel or substantially parallel to each other and face each other with a gap in the thickness direction Xt. The right end of the front surface 12 and the right end of the back surface 13 are connected by the right side surface 14 provided in the thickness direction Xt, the left end of the front surface 12 and the left end of the back surface 13 are connected by the left side surface 15 provided in the thickness direction Xt, the upper end of the front surface 12 and the upper end of the back surface 13 are connected by the top surface 16 provided in the thickness direction Xt, and the lower end of the front surface 12 and the lower end of the back surface 13 are connected by the bottom surface 17 provided in the thickness direction Xt.

The portable information terminal 1 is equipped with a display 20 attached to the housing 11. The display 20 is a touch panel display provided on the front surface 12 of the housing 11, and the display 20 displays a screen to the user using the portable information terminal 1 and accepts input in response to touch operations on the display 20.

Furthermore, the portable information terminal 1 has volume buttons 21 and 22 and a trigger button 23 arranged on the right side surface 14 of the housing 11. The right side surface 14 of the housing 11 has a recessed portion 141 that is recessed inward toward the inside of the housing 11. This recessed portion 141 is extended in the longitudinal direction Xl. The volume buttons 21 and 22 and the trigger button 23 are arranged within the recessed portion 141, aligned in the longitudinal direction Xl in that order from the top. These volume buttons 21 and 22 and the trigger button 23 are positioned above the center M11 of the longitudinal direction Xl of the housing 11. When the volume button 21 is operated by the user, the volume of the speaker of the portable information terminal 1 increases, and when the volume button 22 is operated by the user, the volume of the speaker of the portable information terminal 1 decreases. The trigger button 23 provides a trigger to the portable information terminal 1 to start reading a code when the trigger button 23 is operated by the user. The trigger button 23 has a base portion 231 that is arranged within the recessed portion 141 and extends in the longitudinal direction Xl, and a protruding portion 232 that protrudes outward from the recessed portion 141 from the base portion 231. In the longitudinal direction Xl, the protruding portion 232 is shorter than the base portion 231 and is provided at the center of the base portion 231. This base portion 231 protrudes outward (to the right) from the right side surface 14 (FIG. 1A, FIG. 1B).

Furthermore, the portable information terminal 1 is equipped with a camera module 3 attached to the housing 11. The camera module 3 has a front camera 31 provided on the front surface 12 of the housing 11 and a rear camera unit 32 provided on the rear surface 13 of the housing 11.

The front camera 31 has a camera field (front view) that expands forward from the front surface 12 of the housing 11, and captures the field using a rolling shutter method. In FIG. 1A, the objective lens of the front camera 31 appearing on the front surface 12 of the housing 11 is shown. The front camera 31 is an autofocus camera that automatically adjusts the focus position. The autofocus is executed by adjusting the focus position based on the brightness histogram of the image captured by the front camera 31. The front camera 31 may also be a fixed focus camera.

The rear camera unit 32 is provided protruding from the rear surface 13 of the housing 11 to the rear side in the thickness direction Xt, and has a rear camera 33, a wide-angle illumination unit 34, a narrow-angle illumination unit 35, an aimer light illumination unit 36, and a distance measuring sensor 37. The rear camera 33 has a camera field V33 (rear view) that expands to the rear side from the rear surface 13 of the housing 11, and captures the field using a rolling shutter method. The rear camera 33 is, for example, a color camera capable of generating color images. In FIG. 1B, the objective lens of the rear camera unit 32 appearing on the rear surface 13 of the housing 11 is shown. The rear camera unit 32 is an autofocus camera that automatically adjusts the position of the focus. When using the rear camera unit 32 for photography, autofocus is executed based on the brightness histogram, similar to the front camera 31. Also, when using the rear camera unit 32 for code reading, autofocus is executed based on the detection result of the distance measuring sensor 37, as described later. The wide-angle illumination unit 34 emits wide-angle illumination light L34, which is illumination light with a relatively wide light distribution angle, to the rear side from the rear surface 13 of the housing 11. The narrow-angle illumination unit 35 emits narrow-angle illumination light L35, which is illumination light with a narrower light distribution angle than the wide-angle illumination light L34, to the rear side from the rear surface 13 of the housing 11. The aimer light illumination unit 36 emits aimer light L36, which is visible light, to the rear side from the rear surface 13 of the housing 11. The distance measuring sensor 37 is, for example, a TOF (Time of Flight) sensor, and emits distance measuring light L37 to the rear side from the rear surface 13 of the housing 11 and measures distance to measurement target based on time from emitting the distance measuring light L37 until detecting the distance measuring light L37 reflected by measurement target.

As shown in FIG. 1E, the wide-angle illumination unit 34, distance measuring sensor 37, rear camera 33, and aimer light illumination unit 36 are arranged in this order in the short direction Xs. In other words, in the short direction Xs, the aimer light illumination unit 36 is positioned on one side of the rear camera 33, while the distance measuring sensor 37 and wide-angle illumination unit 34 are positioned on the other side of the rear camera 33. The rear camera 33 is located between the distance measuring sensor 37 and the aimer light illumination unit 36, and the distance measuring sensor 37 is located between the rear camera 33 and the wide-angle illumination unit 34. The narrow-angle illumination unit 35 is positioned below the rear camera 33 in the long direction Xl. The optical axes of the rear camera 33, wide-angle illumination unit 34, narrow-angle illumination unit 35, aimer light illumination unit 36, and distance measuring sensor 37 are extended in the thickness direction Xt and are parallel or substantially parallel to each other. The optical axis of the rear camera 33 is separated from the optical axis of the wide-angle illumination unit 34 by a distance K34, the optical axis of the rear camera 33 is separated from the optical axis of the narrow-angle illumination unit 35 by a distance K35, the optical axis of the rear camera 33 is separated from the optical axis of the aimer light illumination unit 36 by a distance K36, and the optical axis of the rear camera 33 is separated from the optical axis of the distance measuring sensor 37 by a distance K37. Here, the optical axis of the distance measuring sensor 37 is a virtual axis that extends parallel or substantially parallel to each optical axis, positioned midway between the optical axis of the optical system that emits the distance measuring light 37 and the optical axis of the system that focuses the distance measuring light L37 on to the optical sensor. Furthermore, the distance K34 between the rear camera 33 and the wide-angle illumination unit 34 is longer than the distances K35, K36, and K37 between the rear camera 33 and the narrow angle illumination unit 35, the aimer light illumination unit 36, and the distance measuring sensor 37, respectively.

As shown in FIG. 1F, the rear camera 33 has a camera field of view V33 that extends to the rear side in the thickness direction Xt. In contrast, the wide-angle illumination unit 34 irradiates wide-angle illumination light L34 within the camera field of view V33, and the narrow-angle illumination unit 35 irradiates narrow-angle illumination light L35 within the camera field of view V33. The light distribution angle of the narrow-angle illumination light L35 is smaller than that of the wide-angle illumination light L34, and the irradiation range of the narrow-angle illumination light L35 is included in the irradiation range of the wide-angle illumination light L34. The aimer light illumination unit 36 irradiates aimer light L36 within the camera field of view V33, and the distance measuring sensor 37 irradiates distance measuring light L37 within the camera field of view V33. The aimer light L36 and the distance measuring light L37 are irradiated at approximately the center of the camera field of view V33, and the irradiation ranges of the aimer light L36 and the distance measuring light L37 are included in the irradiation range of the wide-angle illumination light L34 and the irradiation range of the narrow-angle illumination light L35.

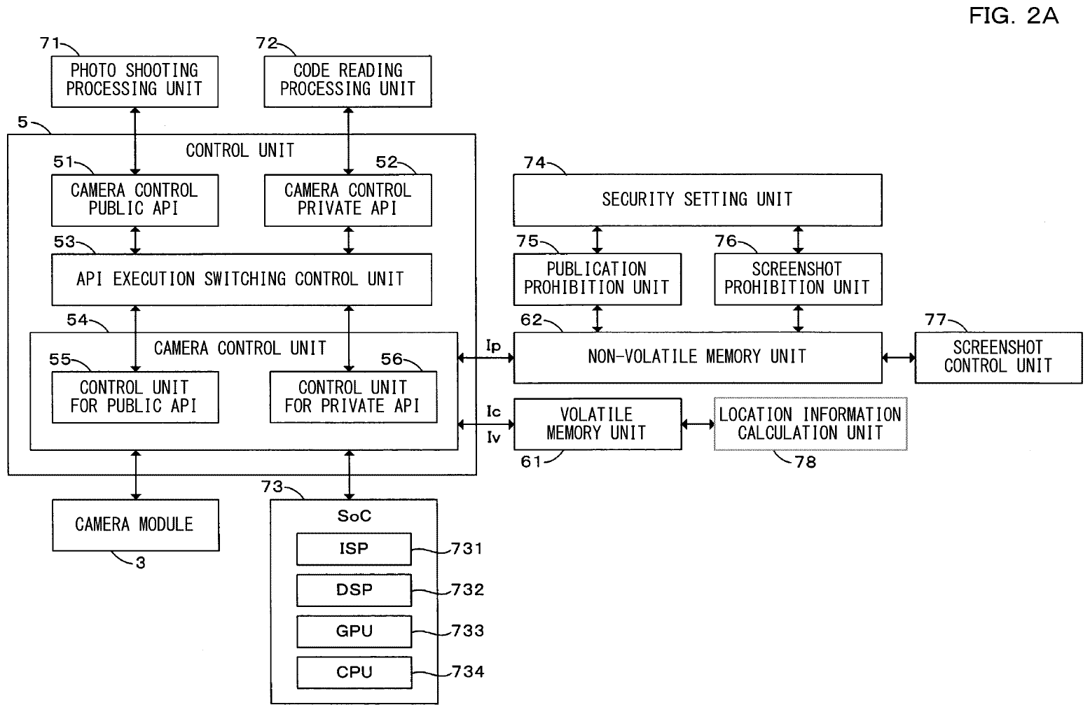

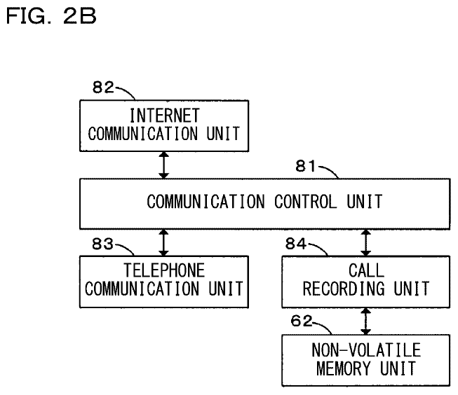

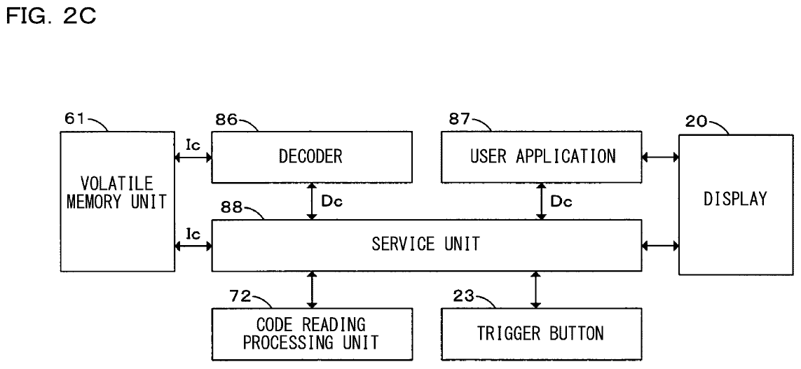

FIG. 2A is a block diagram showing the electrical configuration of the portable information terminal shown in FIG. 1A, mainly illustrating the configuration for controlling the camera module. The portable information terminal 1 includes a control unit 5 that controls the camera module 3, a volatile memory unit 61, and a non-volatile memory unit 62. The control unit 5 is, for example, a processor that controls the camera module 3 and manages data storage to the volatile memory unit 61 and the non-volatile memory unit 62. The volatile memory unit 61 is, for example, RAM (Random Access Memory) that temporarily stores data. The non-volatile memory unit 62 is, for example, an ROM (Read-Only Memory), Flash Memory such as NAND flash memory, SSD (Solid State Drive) or HDD (Hard Disk Drive) that permanently stores data. Furthermore, the portable information terminal 1 is equipped with a photo shooting processing unit 71 that executes photo shooting by the control unit 5 using the camera module 3, and a code reading processing unit 72 that executes code reading by the control unit 5 using the camera module 3. The photo shooting processing unit 71 and the code reading processing unit 72 are processes generated by the processor mounted in the portable information terminal 1 executing a predetermined program.

The photo shooting processing unit 71 saves the setting values (photo shooting setting values) set in the camera module 3 for taking pictures using the front camera 31 or the rear camera 33 in the non-volatile memory unit 62. The photo shooting setting values include, for example, the exposure time of the front camera 31 or the rear camera 33, the brightness of the wide-angle illumination light L34 emitted from the wide-angle illumination unit 34 to the camera field of view V33, and the focus position of the front camera 31 or the rear camera 33. The code reading processing unit 72 saves the setting values (code reading setting values) set in the camera module 3 for reading codes using the rear camera 33 in the non-volatile memory unit 62. The code reading setting values include, for example, the exposure time of the rear camera 33, the brightness of the narrow-angle illumination light L35 emitted from the narrow-angle illumination unit 35 to the camera field of view V33, the focus position of the rear camera 33, and the size of the code that is the reading target.

The control unit 5 has a camera control public API 51, a camera control private API 52, an API execution switching control unit 53, and a camera control unit 54, where the camera control unit 54 has a control unit 55 for public API and a control unit 56 for private API. These units of the control unit 5 are processes generated by a processor mounted in the portable information terminal 1 executing a predetermined program in the non-volatile memory unit 62.

When the Camera Control Public API 51 receives a photo capture instruction that instructs the execution of photo shooting from the Photo Shooting Processing Unit 71, the API Execution Switching Control Unit 53 manages the execution of photo shooting based on the determination result of whether the security mode is set or not. The setting of the security mode is executed by the administrator's operation on the Security Setting Unit 74, which will be described later. If the security mode is not set (in other words, if the normal mode is set), the API Execution Switching Control Unit 53 permits photo shooting and sends the photo capture instruction to the Control Unit for Public API 55. Therefore, the Control Unit for Public API 55 reads the photo capture setting value from the Non-volatile Memory Unit 62 and operates the Camera Module 3 based on this photo capture setting value. In other words, the Control Unit for Public API 55 acquires the photo image Ip (captured image) captured by the front camera 31 or the rear camera 33, and stores the photo image Ip in the Non-volatile Memory Unit 62. On the other hand, if the security mode is set, the API Execution Switching Control Unit 53 prohibits photo shooting and does not send the photo capture instruction to the Control Unit for Public API 55. Therefore, the Control Unit for Public API 55 does not execute photo shooting using the Camera Module 3.

When the camera control private API 52 receives a code reading instruction that instructs the execution of code reading from the code reading processing unit 72, the API execution switching control unit 53 sends the code reading instruction to the private API control unit 56. Therefore, the private API control unit 56 reads the code reading setting value from the non-volatile memory unit 62 and operates the camera module 3 based on this code reading setting value. In other words, the private API control unit 56 acquires the code image Ic (captured image) captured by the rear camera 33 in the camera field of view V33 and stores it in the volatile memory unit 61. As will be described later, a decoding process is executed on the code image Ic stored in the volatile memory unit 61. Furthermore, if the administrator has set the non-volatile storage of the code image Ic, the private API control unit 56 saves the code image Ic in the non-volatile memory unit 62, while if the administrator has not set the non-volatile storage of the code image Ic, the private API control unit 56 does not save the code image Ic in the non-volatile memory unit 62.

In addition, the portable information terminal 1 is equipped with an SoC (System on Chip) 73. This SoC 73 includes an ISP (Image Signal Processor) 731, a DSP (Digital Signal Processor) 732, a GPU (Graphic Processing Unit) 733, and a CPU (Central Processing Unit) 734. The ISP 731 receives a photo image Ip or a code image Ic from the front camera 31 or the rear camera 33 of the camera module 3 and performs specific corrections to these images that are unique to the front camera 31 or the rear camera 33. The specific corrections for the camera correspond to the correction of errors caused by the characteristics of the camera's optical system and image sensor. Thus, the SoC 73 executes appropriate signal processing on the photo image Ip or the code image Ic corrected by the ISP 731 using the DSP 732, GPU 733, or CPU 734. The control unit for the public API 55 and the control unit for the private API 56 store the photo image Ip or the code image Ic, on which signal processing has been performed by the SoC 73, in the non-volatile memory unit 62 or the volatile memory unit 61.

Furthermore, the portable information terminal 1 is equipped with a security setting unit 74, a publication prohibition unit 75, a screenshot prohibition unit 76, and a screenshot control unit 77. The security setting unit 74 displays the administrator setting screen on the display 20 and accepts the administrator's setting operation for the display 20. Specifically, when the administrator performs an operation to instruct the setting of the security mode on the administrator setting screen, the security setting unit 74 sets the security mode, and when the administrator performs an operation to instruct the release of the security mode on the administrator setting screen, the security setting unit 74 releases the security mode. The security setting unit 74 displays the administrator setting screen on the display 20 when the security setting unit 74 confirms that a predetermined password has been entered on the display 20. The publication prohibition unit 75 prohibits the publication of the photo image Ip or the code image Ic captured by the front camera 31 or the rear camera 33 when the security mode is set.

The screenshot prohibition unit 76 prohibits screenshots of the display 20 when the security mode is set. The screenshot control unit 77 does not execute the screenshot if the screenshot is prohibited by the screenshot prohibition unit 76, ignoring the execution instruction for the screenshot. Instead of prohibiting the screenshot, the screenshot control unit 77 may save an image in the non-volatile memory unit 62 that is either disabled (replacing all pixel values with a constant pixel value) or masked (replacing it with an image composed of a mask with a constant pixel value).

Furthermore, the portable information terminal 1 has a location information calculation unit 78. The location information calculation unit 78 calculates the location information of the portable information terminal 1 using GNSS (Global Navigation Satellite System). The location information of the portable information terminal 1 calculated by the location information calculation unit 78 is stored in the volatile memory unit 61.

FIG. 2B is a block diagram showing the electrical configuration of the portable information terminal shown in FIG. 1A, mainly illustrating the configuration that controls communication with the outside of the portable information terminal 1. The portable information terminal 1 includes a communication control unit 81, an internet communication unit 82, a telephone communication unit 83, and a call recording unit 84. The internet communication unit 82 communicates with external servers via the internet, the telephone communication unit 83 conducts calls with external telephone terminals through communication lines (including telephone lines, LAN lines, and internet lines), and the call recording unit 84 stores the voice data of calls made by the telephone communication unit 83 in the non-volatile memory unit 62. Furthermore, the operations of the internet communication unit 82, the telephone communication unit 83, and the call recording unit 84 are controlled based on the determination result by the communication control unit 81 regarding whether the security mode is set or not.

That is, the communication control unit 81 permits the internet connection by the internet communication unit 82 when it is determined that the security mode is not set. The communication control unit 81 prohibits the internet connection by the internet communication unit 82 when it is determined that the security mode is set.

In addition, the communication control unit 81 has a registered telephone number list indicating registered telephone numbers. If the communication control unit 81 determines that the security mode is not set, it allows calls from both the telephone terminal of the telephone number included in the registered telephone number list and the telephone terminal of the telephone number not included in the registered telephone number list via the telephone communication unit 83. If the communication control unit 81 determines that the security mode is set, it allows calls between the telephone terminal of the telephone number included in the registered telephone number list and the telephone communication unit 83, while prohibiting calls between the telephone terminal of the telephone number not included in the registered telephone number list and the telephone communication unit 83.

The communication control unit 81 permits the storage of voice data in the non-volatile memory unit 62 by the call recording unit 84 when it is determined that the security mode is not set. The communication control unit 81 prohibits the storage of voice data in the non-volatile memory unit 62 by the call recording unit 84 when it is determined that the security mode is set.

FIG. 2C is a block diagram showing the electrical configuration of the portable information terminal shown in FIG. 1A, primarily illustrating the configuration for controlling code reading by the portable information terminal 1. The portable information terminal 1 includes a decoder 86 (image processing unit), a user application 87, and a service unit 88. Each of the decoder 86, user application 87, and service unit 88 is a process generated by a processor mounted in the portable information terminal 1 executing a predetermined program. The service unit 88 functions as a backend that coordinates the operations of the decoder 86, user application 87, code reading processing unit 72, trigger button 23, and display 20.

The service unit 88 confirms that the trigger button 23 has been pressed by the user, sends a code reading instruction to the code reading processing unit 72, and the code reading processing unit 72 outputs the code reading instruction received from the service unit 88 to the camera control private API 52. In response to receiving the code reading instruction from the camera control private API 52, the code image Ic is obtained by the camera module 3 according to the aforementioned procedure. That is, the control unit for the private API 56 sets the code reading setting value read from the non-volatile memory unit 62 to the camera module 3. Then, the control unit for the private API 56 causes the narrow-angle illumination light L35 to be emitted from the narrow-angle illumination unit 35 while capturing the camera field of view V33 with the rear camera 33. At this time, the control unit for the private API 56 adjusts the focus position of the rear camera 33 to match the position of the code on the workpiece based on the result of detecting the distance to the code (specifically, the workpiece with the code) measured by the distance measuring sensor 37. Thus, when the focus of the rear camera 33 is in a state matched to workpiece, the irradiation positions of the aimer light L36 and the distance measuring light L37 on the workpiece W are included in depth of field of the rear camera 33. Then, the control unit for private API 56 executes imaging with the rear camera 33. As a result, the entire image of the camera field of view V33 containing code is obtained as the code image Ic, and the code image Ic is stored in the volatile memory unit 61. At this time, the control unit for private API 56 repeatedly acquires code image Ic at a predetermined frame cycle and overwrites it in volatile memory unit 61. Therefore, only latest code image Ic is stored in the volatile memory unit 61.

Then, the service unit 88 confirms that the trigger button 23 has been pressed by the user and, after a predetermined waiting time (for example, 1 second) has elapsed, requests the decoder 86 to execute the decoding process at that timing. As a modified example, the service unit 88 may request the decoder 86 to execute the decoding process at the timing when the trigger button 23 is pressed by the user (that is, without waiting time). The decoder 86, upon receiving the request from the service unit 88, reads the code image Ic stored in the volatile memory unit 61 and executes the decoding process on the code image Ic. As a result, the reading data Dc indicated by the code image Ic is read by the decoder 86. This reading data Dc is, for example, text data.

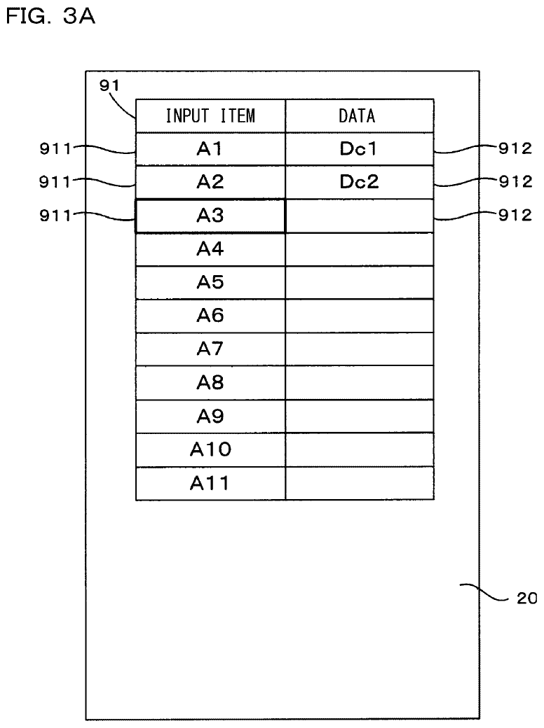

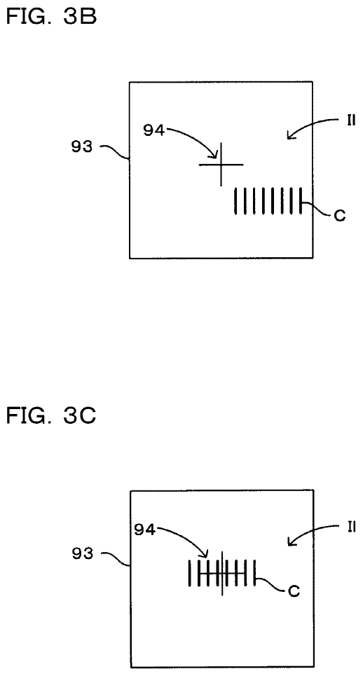

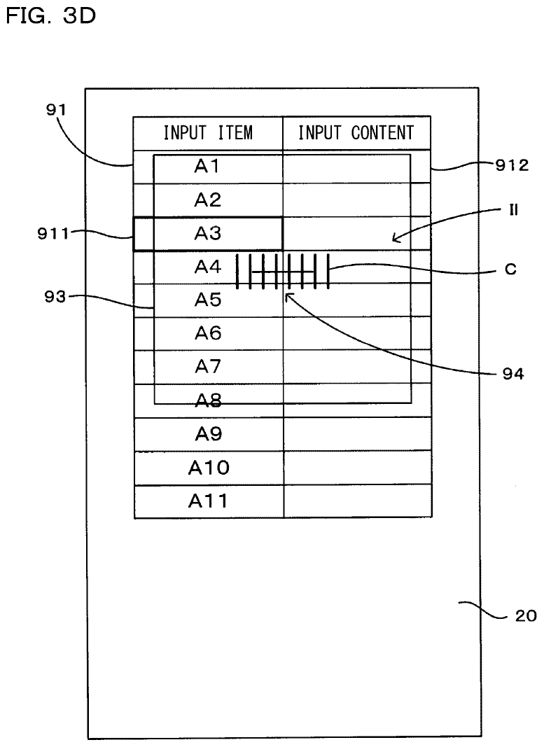

The decoder 86 sends the reading data Dc to the service unit 88, and the service unit 88 sends the reading data Dc received from the service unit 88 to the user application 87. The user application 87 inputs the reading data Dc received from the decoder 86 into a predetermined input item. At this time, the user application 87 displays a user application screen 91 (FIG. 3A) on the display 20 to assist the user in inputting the reading data Dc.

FIG. 3A is a diagram showing an example of a user application screen. The user application screen 91 in FIG. 3A is displayed on the display 20 in conjunction with the execution of the user application 87. The user application screen 91 has multiple input fields 911 that each indicate input items A1, A2, . . . , and multiple data display fields 912 that each indicate reading data Dc input into the multiple input items A1, A2, . . . . In the example of FIG. 3A, reading data Dc1 and Dc2 have been input for input items A1 and A2, respectively, while reading data Dc has not been input for input items A3, A4, . . . . In addition, the user application 87 is focusing on the input item A3 selected by the user's operation on the display 20. When the user presses the trigger button 23 in this state, reading data Dc3 is obtained by the service unit 88 according to the aforementioned procedure and sent to the user application 87. Then, the user application 87 inputs the reading data Dc3 received from the service unit 88 into the focused input item A3. As a result, the reading data Dc3 is displayed in the data display field 912 corresponding to the input item A3 on the user application screen 91.

Furthermore, the service unit 88 displays an image view window 93 (FIG. 3B, FIG. 3C) on the display 20 to assist the user in reading the code. FIGS. 3B and 3C show an example of the image view window. The image view window 93 has a rectangular shape and displays the code image Ic stored in the volatile memory unit 61. The image view window 93 is an image view window (also called a live view window) that updates the image by capturing images periodically. Not limited to this, the image view window 93 may also update the screen with the captured image when the decoder 86 successfully reads it. This image view window 93 is displayed on the display 20 by the service unit 88 in conjunction with the activation of the rear camera 33 of the camera module 3. Therefore, for example, in response to the pressing of the trigger button 23, the service unit 88 displays the image view window 93 on the display 20. In other words, when the service unit 88 confirms the pressing of the trigger button 23, it sends a code reading instruction to the code reading processing unit 72. When this code reading instruction is received by the code reading processing unit 72, the rear camera 33 is activated for code reading according to the aforementioned procedure, and the display of the image view window 93 on the display 20 begins.

As described above, when the trigger button 23 is pressed by the user, the code image Ic is acquired at a predetermined frame cycle and overwritten in the volatile memory 61. In contrast, the service unit 88 reads the code image Ic stored in the volatile memory 61 at the frame cycle, acquires the image of the central portion of the code image Ic as the image view image Il, and displays it in the image view window 93 currently displayed on the display 20. In the examples of FIG. 3B and FIG. 3C, the code C included in the camera field of view V33 is projected in the image view image Il.

Furthermore, the service unit 88 displays the virtual aimer 94 at the center of the image view window 93. Therefore, the user holding the portable information terminal 1 can align the virtual aimer 94 displayed in the image view image Il with the code C. As a result, the virtual aimer 94, which is offset from the code C as shown in FIG. 3B, can be matched with the code C as shown in FIG. 3C. This allows the code C to be positioned at the center of the camera field of view V33. Then, when the decoder 86 completes the decoding process for the code image Ic, the service unit 88 ends the display of the image view image Il on the display 20. The display of the image view image Il starts simultaneously with the confirmation of the pressing of the trigger button 23, while the decoding process of the decoder 86 starts after the waiting time has elapsed from the confirmation of the pressing of the trigger button 23. Therefore, the image view image Il is continuously displayed on the display 20 for at least the waiting time.

Furthermore, the service unit 88 displays the image view window 93 on the display 20 together with the user application screen 91 displayed by the user application 87 (FIG. 3D). Here, FIG. 3D is a diagram showing an example of the display mode of the user application screen and the image view window. As shown in FIG. 3D, the service unit 88 displays the image view window 93 over the user application screen 91. In other words, the image view window 93 is displayed in front of the user application screen 91. At this time, the service unit 88 displays the image view window 93 in a semi-transparent manner. Therefore, the overlapping portion of the user application screen 91 with the image view window 93 is displayed in a semi-transparent manner. In other words, the overlapping portion is displayed on the display 20 so that it can be visually recognized by the user. In the example of FIG. 3D, the input item A3, which is focused by the user, is included in the overlapping portion, but it is visually recognizable by the user because it is displayed in a semi-transparent manner through the image view window 93.

At this time, the service unit 88 adjusts the transparency rate, which is the degree to which the image view window 93 allows the user application screen 91 to be seen through. Specifically, the service unit 88 calculates a representative value that represents the saturation of the image in the image view window 93. For example, the maximum value, average value, or median value of the saturation in the image view window 93 is calculated as the representative value. Then, the service unit 88 sets a larger transparency rate as the saturation (representative value) of the image displayed in the image view window 93 increases.

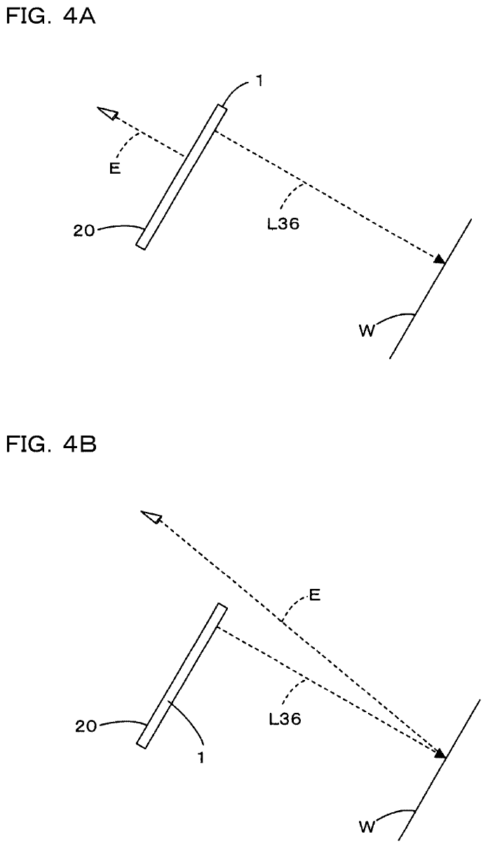

In addition, along with the display of the virtual aimer 94 on the image view image Il, the irradiation of the aimer light L36 by the aimer light illumination unit 36 is also executed. That is, when the private API control unit 56 receives a code reading instruction from the code reading processing unit 72, it causes the aimer light illumination unit 36 to irradiate the aimer light L36. Therefore, the user can perform alignment between the camera field of view V33 and the code C by the virtual aimer 94 as described above, and can also perform alignment between the camera field of view V33 and the code C by the aimer light L36 (in other words, the real aimer) irradiated on the workpiece with the code C attached (FIG. 4A, FIG. 4B).

FIG. 4A is a schematic diagram showing the alignment state using a virtual aimer, and FIG. 4B is a schematic diagram showing the alignment state using aimer light. In both examples of FIG. 4A and FIG. 4B, the aimer light L36 emitted from the aimer light illumination unit 36 is irradiated onto the workpiece W with the code C attached. However, in the example of FIG. 4A, the user's line of sight E is hidden by the portable information terminal 1 and does not reach the aimer light L36 on the workpiece W. Therefore, the user cannot visually recognize the aimer light L36 and performs alignment based on the virtual aimer 94 displayed on the display 20. On the other hand, in the example of FIG. 4B, the user's line of sight E reaches the aimer light L36 on the workpiece W without being hidden by the portable information terminal 1. Therefore, even if the user cannot visually recognize the display 20, the user can visually recognize the aimer light L36 and perform alignment based on the aimer light L36 irradiated onto the workpiece W.

Furthermore, the portable information terminal 1 is capable of executing a single code reading mode that reads a single code C as illustrated in FIGS. 3B and 3C, and a multiple code reading mode that reads multiple codes C simultaneously. Next, the multiple code reading mode will be described.

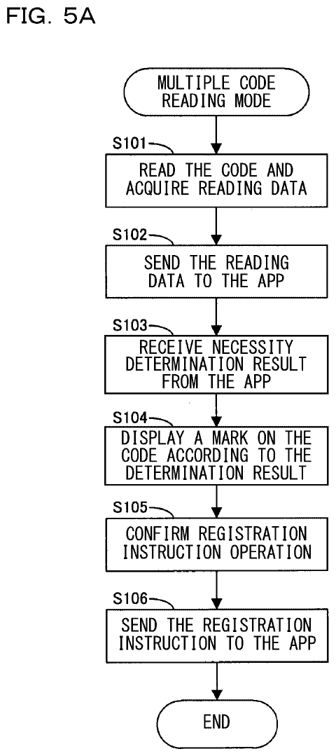

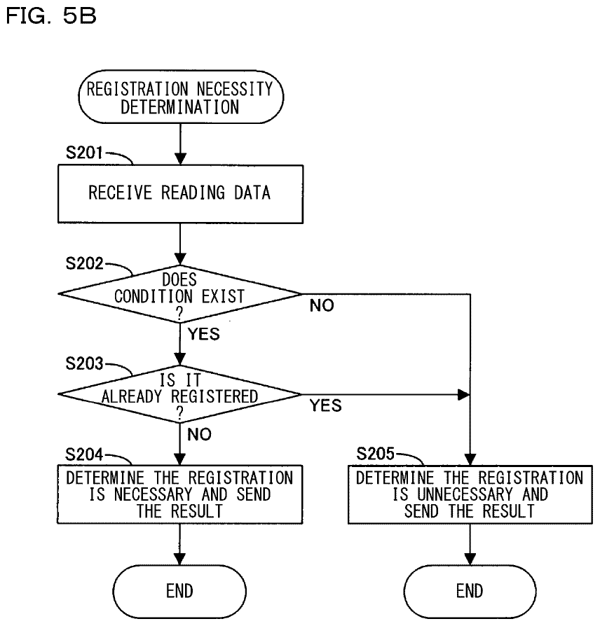

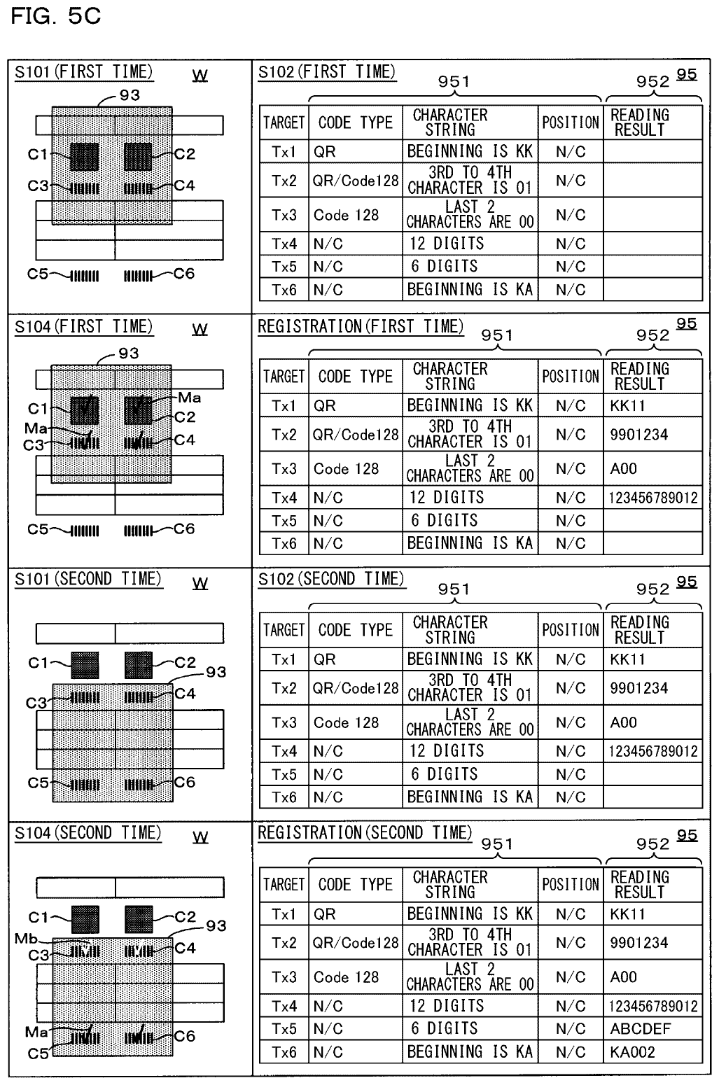

FIG. 5A is a flowchart showing an example of a multiple code reading mode executed by the service unit, and FIG. 5B is a flowchart showing an example of registration necessity determination executed by the user application according to the multiple code reading mode of FIG. 5A, and FIG. 5C is a diagram schematically showing the operation executed in the multiple code reading mode of FIG. 5A. In FIG. 5C, the operation of reading six codes C1 to C6 attached to a workpiece W, which is a form, is exemplified. In this example, the reading data Dc, which is the result of reading the code C, is registered in the data management table 95 held by the user application 87.

This data management table 95 shows the data registration conditions 951 that the reading data Dc must satisfy and the reading results 952 that serve as the registration destination for the reading data Dc, for each of the six reading targets Tx1 to Tx6. The data registration conditions 951 are composed of a combination of code type, character string, and position. The code type indicates the code type conditions required for the type of code C corresponding to the reading data Dc, the character string indicates the character string conditions required for the character strings included in the reading data Dc, and the position indicates the position conditions required for the position of the code C corresponding to the reading data Dc in the workpiece W. In this example, the position condition is N/C (No Care) and is therefore invalid. It should be noted that the conditions included in the data registration conditions 951 are not limited to this example. The data registration conditions 951 may also include numerical conditions required for the numerical values included in the reading data Dc.

In step S101, the service unit 88 has the decoder 86 perform decoding processing on the code image Ic obtained by imaging the code C included in the image view window 93, thereby acquiring the reading data Dc of the code C. In the example shown in the column “S101 (1st time)” of FIG. 5C, out of the six codes C1 to C6, four codes C1 to C4 are included in the image view window 93. Therefore, the code image Ic including the four codes C1 to C4 is obtained and stored in the volatile memory 61, and the decoder 86 performs decoding processing on the images of each of the codes C1 to C4 included in the code image Ic. As a result, the service unit 88 acquires four reading data Dc1 to Dc4 corresponding to the four codes C1 to C4, respectively.

In step S102, the service unit 88 sends the four pieces of reading data Dc1 to Dc4 obtained in step S101 to the user application 87. In response, the user application 87 executes the necessity determination for registration shown in FIG. 5B. It should be noted that the user application 87 performs the necessity determination for registration for each of the four pieces of reading data Dc1 to Dc4, but here, the necessity determination for registration for one piece of reading data Dc is explained.

User application 87 receives reading data Dc from service unit 88 (step S201), and collates reading data Dc with data management table 95 to determine the necessity of registering reading data Dc into data management table 95 (steps S202 to S205). In step S202, user application 87 checks whether there exists any data registration condition 951 among the data registration conditions 951 of reading targets Tx1 to Tx6 that reading data Dc satisfies. If no applicable data registration condition 951 exists (in step S202, if “NO”), user application 87 determines that reading data Dc is not a reading target and thus registration is unnecessary, and sends that determination result to service unit 88 (step S205).

If the corresponding data registration condition 951 exists (in the case of “YES” in step S202), the user application 87 determines whether the read data Dc is already registered in the reading result 952 corresponding to the relevant data registration condition 951 (step S203). If it is already registered (in the case of “YES” in step S203), the user application 87 determines that the read data Dc is already registered and therefore unnecessary for registration, and sends that determination result to the service unit 88 (step S205). If it is not registered (in the case of “NO” in step S203), the user application 87 determines that the read data Dc is necessary for registration and sends that determination result to the service unit 88 (step S204).

In the example shown in the column “S102 (1st time)” of FIG. 5C, each of the reading data Dc1 to Dc4 is determined to satisfy the data registration conditions 951 of the reading targets Tx1 to Tx4 (“YES” in step S202). Furthermore, since the reading results 952 corresponding to each of the reading targets Tx1 to Tx4 are empty and the reading data Dc1 to Dc4 are unregistered, the reading data Dc1 to Dc4 is determined to be necessary for registration (steps S203, S204).

As shown in FIG. 5A, when the service unit 88 receives the necessity determination result from the user application 87 (step S103), it attaches a mark corresponding to the determination result to codes C1 to C4 in the image view window 93 (step S104). In this example, since codes C1 to C4 (in other words, the corresponding reading data Dc1 to Dc4) are determined to require registration, the service unit 88 displays a mark Ma indicating that registration is necessary (for example, a black check mark) for codes C1 to C4 (in the column of “S104 (1st time)” in FIG. 5C).

The service unit 88 confirms the user's flick operation (registration instruction operation) on the display 20 where the image view window 93 is displayed (step S105), and sends a registration instruction to the user application 87 to register the reading data Dc1 to Dc4, which is determined to be necessary for registration, into the reading result 952 of the data management table 95 (step S106). When the user application 87 receives the registration instruction from the service unit 88, it registers the reading data Dc1 to Dc4 indicated by the registration instruction into the reading results 952 of the corresponding reading targets Tx1 to Tx4 (the column of “registration (first time)” in FIG. 5C).

In the example shown in the column “S101 (second time)” of FIG. 5C, out of the six codes C1 to C6, four codes C3 to C6 are included in the image view window 93, and the service unit 88 acquires four reading data Dc3 to Dc6 corresponding to the four codes C3 to C6.

In step S102, the service unit 88 sends the four pieces of reading data Dc3 to Dc6 obtained in step S101 to the user application 87. In response, the user application 87 executes the necessity determination for registration shown in FIG. 5B. In the example shown in the column “S102 (2nd time)” of FIG. 5C, each of the reading data Dc3 to Dc6 is determined to satisfy the data registration conditions 951 of the reading targets Tx3 to Tx6 (“YES” in step S202).

However, since the reading data Dc3 and Dc4 corresponding to the reading targets Tx3 and Tx4 are already registered in the reading result 952, the reading data Dc3 and Dc4 are determined to be unnecessary for registration (steps S203, S205). Therefore, the determination result that the reading data Dc3 and Dc4 are unnecessary for registration because they are already registered is sent from the user application 87 to the service unit 88. On the other hand, since the reading results 952 corresponding to the reading targets Tx5 and Tx6 are empty and the reading data Dc5 and Dc6 are unregistered, the reading data Dc5 and Dc6 are determined to be necessary for registration (steps S203, S204). Therefore, the determination result that the reading data Dc5 and Dc6 are necessary for registration is sent from the user application 87 to the service unit 88.

As shown in FIG. 5A, the service unit 88 receives the necessity determination result from the user application 87 (step S103) and attaches a mark corresponding to the determination result to codes C3 to C6 in the image view window 93. In this example, codes C3 and C4 (in other words, the corresponding reading data Dc3 and Dc4) are determined to be unnecessary for registration because they are already registered. Therefore, the service unit 88 displays a mark Mb (for example, a white check mark) indicating that they are registered for codes C3 and C4 (in the column of “S104 (second time)” in FIG. 5C). Additionally, codes C5 and C6 (in other words, the corresponding reading data Dc5 and Dc6) are determined to require registration. Therefore, the service unit 88 displays a mark Ma indicating that registration is necessary for codes C5 and C6 (in the column of “S104 (second time)” in FIG. 5C).

In the example of FIG. 5C, a mark Ma indicating the necessity of registration and a mark Mb indicating that registration is unnecessary because it is already registered are shown, but the types of marks are not limited to these. In other words, when the reading data Dc is determined to be unnecessary for registration because it is not a reading target, a mark of a different form from marks Ma and Mb may be displayed as a mark indicating this determination result.

The service unit 88 confirms the user's flick operation (registration instruction operation) on the display 20 where the image view window 93 is displayed (step S105), and sends a registration instruction to the user application 87 to register the reading data Dc5 and Dc6, which are determined to require registration, into the reading result 952 of the data management table 95 (step S106). When the user application 87 receives the registration instruction from the service unit 88, it registers the reading data Dc5 and Dc6 indicated by the registration instruction into the reading results 952 of the corresponding reading targets Tx5 and Tx6 (the “registration (second time)” column in FIG. 5C).

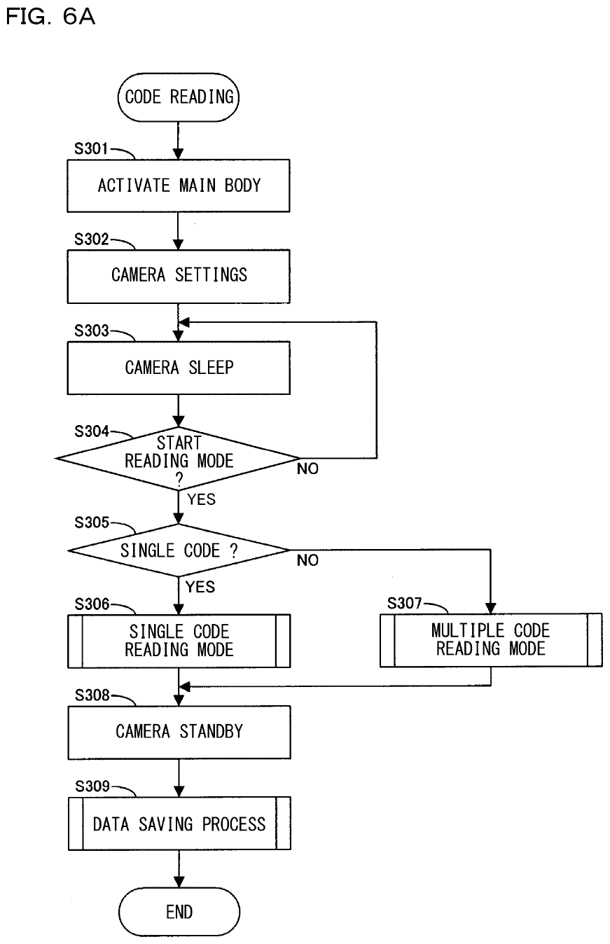

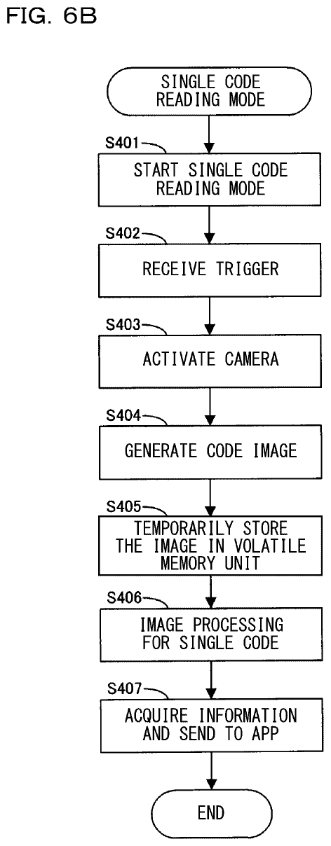

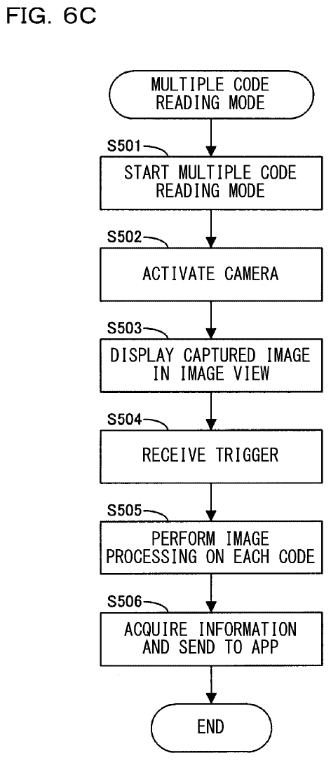

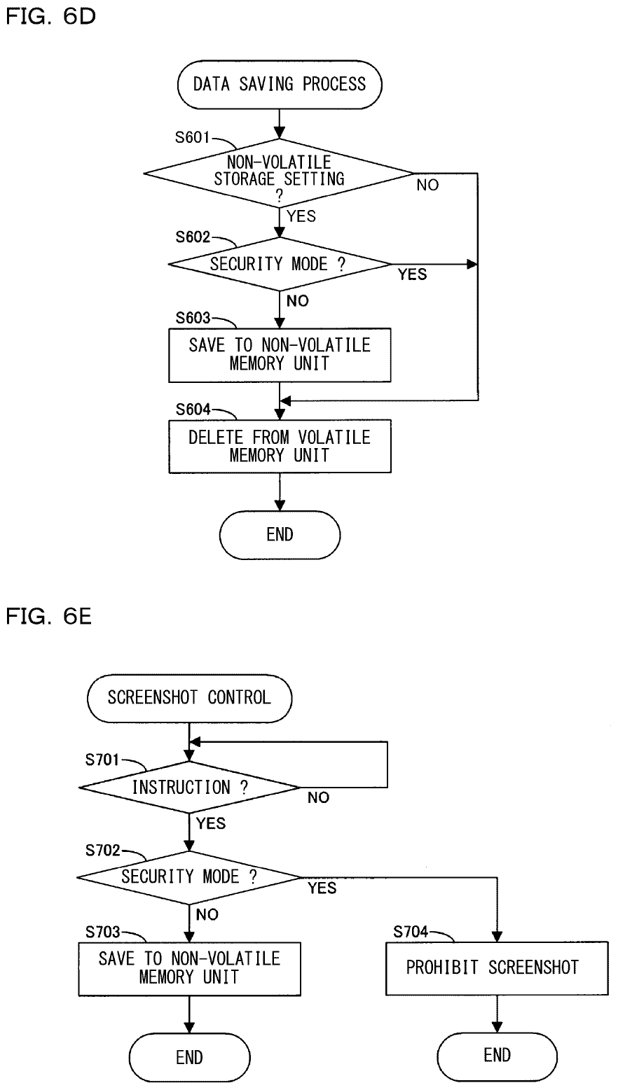

FIG. 6A is a flowchart showing an example of code reading executed by a portable information terminal, and FIG. 6B is a flowchart showing an example of a single code reading mode executed in the code reading of FIG. 6A, and FIG. 6C is a flowchart showing an example of a multiple code reading mode executed in the operation of FIG. 6A, and FIG. 6D is a flowchart showing an example of data saving process executed in the code reading of FIG. 6A.

In step S301 of FIG. 6A, the main body of the portable information terminal 1 is activated, and the display 20 is started. In step S302, the camera control unit 54 reads the code reading setting value from the non-volatile memory 62 and sets it to the camera module 3. In addition, the camera control unit 54 also performs initialization of the ISP 731 and the like in step S302. Step S303 is where the camera control unit 54 puts the camera module 3 to sleep.

Then, when the camera control private API 52 receives a code reading instruction from the code reading processing unit 72 (“YES” in step S304), the control unit for private API 56 checks whether the single code reading mode is set (step S305). In other words, the user can set which mode to execute, either the single code reading mode or the multiple code reading mode, to the control unit for private API 56 by operating the display 20. If the single code reading mode is set (“YES” in step S305), the single code reading mode shown in FIG. 6B is executed (step S306). On the other hand, if the multiple code reading mode is set (“NO” in step S305), the multiple code reading mode shown in FIG. 6C is executed (step S307).

In step S401 of FIG. 6B, the non-public API control unit 56 starts the single code reading mode. When the service unit 88 confirms the pressing of the trigger button 23 (step S402), the non-public API control unit 56 activates the rear camera unit 32 of the camera module 3 (step S403). As mentioned above, the image view window 93 is displayed on the display 20 accompanying the activation of the rear camera unit 32.

Then, the control unit for private API 56 generates a code image Ic by the rear camera unit 32 (step S404), and temporarily stores this code image Ic in the volatile memory 61 (step S405). In step S406, the decoder 86 performs decoding processing on the single code C included in the code image Ic, and the reading data Dc is acquired. As mentioned above, the decoding processing is executed at a timing after a predetermined waiting time (for example, 1 second) has elapsed from the confirmation of the trigger button 23 being pressed, or at the timing of the confirmation of the trigger button 23 being pressed. In step S407, the service unit 88 sends the reading data Dc acquired from the decoder 86 to the user application 87. Then, this reading data Dc is registered in the data management table 95 of the user application 87.

In step S501 of FIG. 6C, the private API control unit 56 starts the multiple code reading mode. In step S502, the private API control unit 56 activates the rear camera unit 32 of the camera module 3. As mentioned above, with the activation of the rear camera unit 32, the image view window 93 is displayed on the display 20, and the service unit 88 displays the code image Ic captured by the rear camera unit 32 in the image view window 93 (step S503). At this time, the service unit 88 increases the area of the image view window 93 displayed in the multiple code reading mode compared to the area of the image view window 93 displayed in the single code reading mode. When including multiple codes within the field of view, if the area of the image view window 93 is constant, the size of each code will become smaller, but this configuration can suppress the reduction in size of the codes within the field of view.

The service unit 88 confirms the pressing of the trigger button 23 (step S504), and instructs the decoder 86 to perform the decoding process for the code image Ic stored in the volatile memory unit 61 (step S505). Since the code image Ic contains images of multiple codes C, the decoder 86 executes the decoding process for each of the multiple codes C to obtain multiple reading data Dc. The service unit 88 sends the multiple reading data Dc obtained from the decoder 86 to the user application 87 (step S506), and through the aforementioned flow using FIG. 5A and FIG. 5B, the reading data Dc is registered in the data management table 95 of the user application 87.

As shown in FIG. 6A, when the single code reading mode (step S306) or the multiple code reading mode (step S307) is completed, the non-public API control unit 56 puts the camera module 3 in standby (step S308). Then, in step S309, the non-public API control unit 56 executes the data saving process of FIG. 6D (step S309).

In step S601 of FIG. 6D, the control unit 56 for the private API determines whether the storage of the code image Ic to the non-volatile memory 62 is set or not. In other words, the user can set whether to save the code image Ic to the non-volatile memory 62 by operating the display 20. If the storage to the non-volatile memory 62 is not set (in the case of “NO” in step S601), the control unit 56 for the private API deletes the code image Ic temporarily stored in the volatile memory 61 from the volatile memory 61 (step S604).

On the other hand, when saving to the non-volatile memory 62 is set (in the case of “YES” in step S601), the control unit for private API 56 determines whether the security mode is set (step S602). Specifically, the control unit for private API 56 determines based on the result of receiving a mode selection signal indicating which of the security mode and normal mode is selected from the security setting unit 74. When the security mode is set (in the case of “YES” in step S602), the control unit for private API 56 deletes the code image Ic from the volatile memory 61 (step S604). On the other hand, when the security mode is not set (in the case of “NO” in step S602), in other words, when the normal mode is set, the control unit for private API 56 saves the code image Ic temporarily stored in the volatile memory 61 to the non-volatile memory 62 (step S603), and then deletes the code image Ic from the volatile memory 61 (step S604).

In addition, the execution of the screenshot is appropriately restricted for the display 20 that displays the image view window 93. That is, when the image view window 93 is displayed on the display 20 in the multiple code reading mode, the screenshot control unit 77 accepts the execution instruction of the screenshot and executes the flowchart in FIG. 6E. Here, FIG. 6E is a flowchart showing an example of screenshot control.

The screenshot control unit 77 accepts the execution instruction of the screenshot (if “YES” in step S701), and determines whether the security mode is set (step S702). Then, if the security mode is not set (if “NO” in step S702), the screenshot control unit 77 saves the screenshot image of the display 20 displaying the image view window 93 in the non-volatile memory 62 (step S703).

On the other hand, when the security mode is set (in the case of “YES” in step S702), as mentioned above, the screenshot prohibition unit 76 prohibits the screenshot. Therefore, the screenshot control unit 77 ignores the execution instruction for the screenshot and does not execute the screenshot (step S704). In step S704, the screenshot control unit 77 may disable the screenshot image of the display 20 (replacing all pixel values with a constant pixel value) or save an image that has been masked (replaced with a mask composed of a constant pixel value) in the non-volatile memory unit 62.

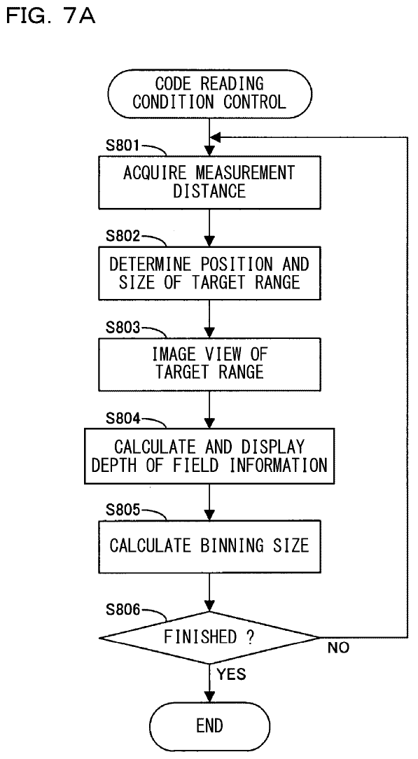

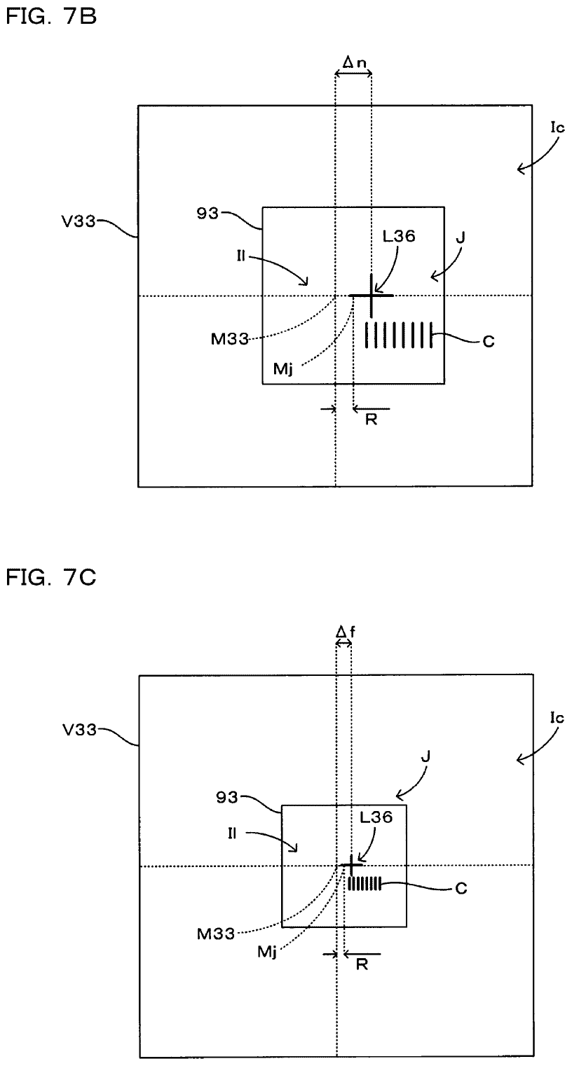

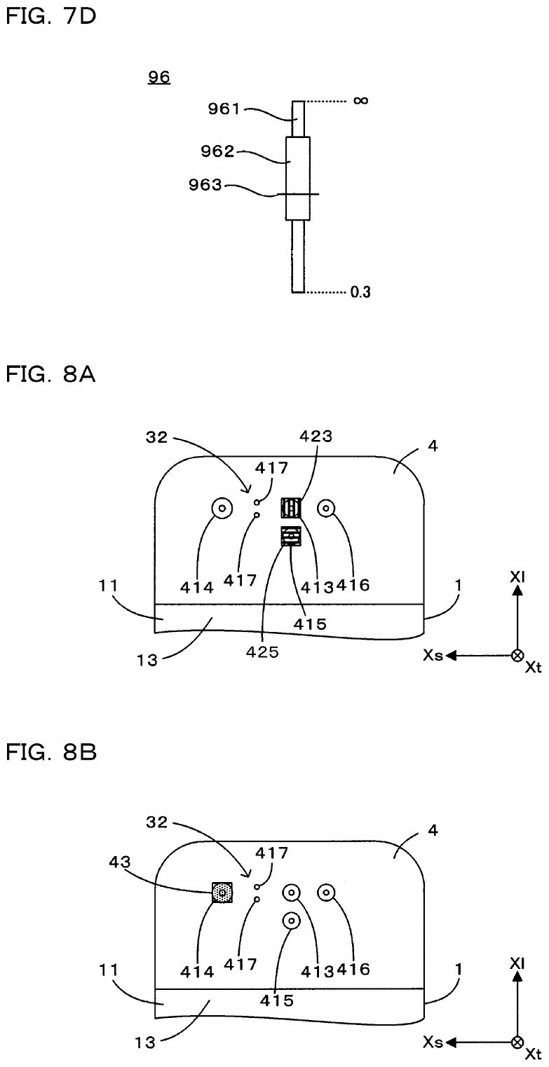

Meanwhile, in the portable information terminal 1 described above, the conditions for executing code reading are controlled based on the distance to the workpiece W measured by the distance measuring sensor 37. FIG. 7A is a flowchart showing an example of code reading condition control, and FIGS. 7B, 7C, and 7D are diagrams schematically showing the operations performed in the code reading condition control of FIG. 7A.

In step S801, the service unit 88 measures the distance to the workpiece W using the distance measuring sensor 37 and acquires the measured distance from the distance measuring sensor 37. In step S802, the service unit 88 determines the position and size of the target range J to be displayed in the image view window 93 from the code image Ic obtained by the rear camera 33 capturing the camera field of view V33, according to the measured distance. This is to correspond to the fact that the distance to the workpiece W affects the spacing between the center M33 of the camera field of view V33 (in other words, the center of the code image Ic) and the aimer light L36, as well as the size of the code C, which changes in the code image Ic.

In FIG. 7B, a case where the distance to the workpiece W is relatively close is shown, and in FIG. 7C, a case where the distance to the workpiece W is relatively far is shown. As can be seen from these comparisons, when the distance to the workpiece W is close (FIG. 7B), the interval Δn between the center M33 of the camera field V33 appearing in the code image Ic and the aimer light L36 is wider than the interval Δf between the center M33 of the camera field V33 appearing in the code image Ic and the aimer light L36 when the distance to the workpiece W is far (FIG. 7C). Furthermore, when the distance to the workpiece W is close (FIG. 7B), the size of the code C appearing in the code image Ic is larger than the size of the code C appearing in the code image Ic when the distance to the workpiece W is far (FIG. 7C).

Therefore, the service unit 88 biases the center Mj of the target range J to be displayed in the image view window 93 from the center M33 of the camera field of view V33 to the irradiation position of the aimer light L36 among the code image Ic. For example, the service unit 88 sets the center Mj of the target range J between the center M33 of the camera field of view V33 and the irradiation position of the aimer light L36. In particular, the service unit 88 narrows the interval R between the center Mj of the target range J in the camera field of view V33 and the center M33 of the camera field of view V33 as the measurement distance becomes longer. Furthermore, the service unit 88 reduces the size of the target range J in the camera field of view V33 as the measurement distance becomes longer. As a result, the farther the measurement distance, the more the aimer light L36 and the code C are enlarged. Then, in step S803 (FIG. 7A), the service unit 88 displays the target range J determined in step S802 in the image view window 93.

In step S804, the service unit 88 calculates the depth of field information 96 based on the measurement distance obtained in step S801 (FIG. 7D). The depth of field information 96 includes the position coordinate 961 up to infinity, the depth of field 962 at the position coordinate 961, and the focus position 963 of the rear camera 33. The depth of field 962 is calculated based on the measurement distance. The focus position 963 is adjusted to match the position of the workpiece W indicated by the measurement distance, as described above. The service unit 88 displays the depth of field information 96 shown in FIG. 7D in the image view window 93. Furthermore, the service unit 88 compares the depth of field 962 with a predetermined depth threshold, and if the depth of field 962 is less than the depth threshold, a warning is displayed in the image view window 93.

In step S805, the service unit 88 sends the measurement distance to the decoder 86, and the decoder 86 calculates the binning size corresponding to the measurement distance. Specifically, the decoder 86 calculates the binning size such that the closer the measurement distance, the larger the binning size. Here, binning refers to an image processing that combines adjacent pixels in the code image Ic into one pixel of a predetermined binning size, and the decoder 86 performs decoding processing on the code image Ic where binning has been executed.

And, until the display of the image view window 93 is ended (in step S806 with “YES”), steps S801 to S805 are repeatedly executed.

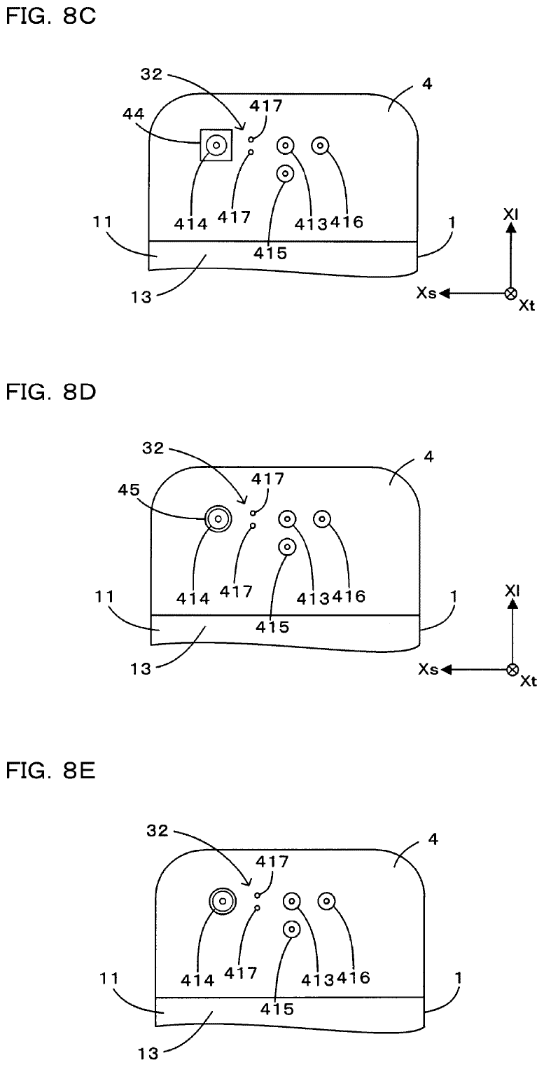

The attachment 4 can be detachably attached to the housing 11 of the portable information terminal 1. FIGS. 8A to 8E are rear views showing examples of the attachment, illustrating the state of the attachment 4 attached to the housing 11. The attachment 4 has an attachment cover 41 that is attachable to the rear 13 of the housing 11, and when the attachment cover 41 is attached to the housing 11, it overlaps the rear side of the rear camera unit 32 in the thickness direction Xt.

The attachment cover 41 has windows 413, 414, 415, 416, and 417 that are opened. When the attachment 4 is attached to the housing 11, the window 413 faces the rear camera 33, the window 414 faces the wide-angle illumination unit 34, the window 415 faces the narrow-angle illumination unit 35, the window 416 faces the aimer light illumination unit 36, and the window 417 faces the distance measuring sensor 37. A pair of windows 417 is provided corresponding to the optical system that emits distance measuring light L37 and the optical system that focuses the distance measuring light L37 onto the optical sensor. Therefore, the rear camera 33 can capture the camera field of view V33 through the window 413, the wide-angle illumination unit 34 can emit wide-angle illumination light L34 through the window 414, the narrow-angle illumination unit 35 can irradiate narrow-angle illumination light L35 through the window 415, the aimer light illumination unit 36 can irradiate aimer light L36 through the window 416, and the distance measuring sensor 37 can irradiate and detect the distance measuring light L37 through the window 417.

In the attachment 4 shown in FIG. 8A, a polarizing plate 423 is attached to the window 413 for the rear camera 33, and a polarizing plate 425 is attached to the window 415 for the narrow-angle illumination unit 35, with the polarization angles of the polarizing plate 423 and the polarizing plate 425 being orthogonal to each other. Therefore, the narrow-angle illumination light L35 emitted from the narrow-angle illumination unit 35 is polarized by the polarizing plate 425 before being irradiated into the camera field V33 of the rear camera 33. Furthermore, the rear camera 33 captures the camera field V33 using the light polarized by the polarizing plate 423.

In the attachment 4 shown in FIG. 8B, a light diffusion plate 43 is attached to the window 414 for the wide-angle illumination unit 34. Therefore, the wide-angle illumination light L34 emitted from the wide-angle illumination unit 34 is diffused by the light diffusion plate 43 before being irradiated onto the camera field V33 of the rear camera 33. This wide-angle illumination light L34 functions as dome-shaped illumination light that is irradiated from all directions onto the camera field V33.

In the attachment 4 shown in FIG. 8C, a prism mirror 44 is attached to a window 414 for the wide-angle illumination unit 34. Therefore, the wide-angle illumination light L34 emitted from the wide-angle illumination unit 34 is irradiated onto the camera field of view V33 of the rear camera 33 via the prism mirror 44. This prism mirror 44 has the function of reducing the angle at which the wide-angle illumination light L34 is irradiated onto the camera field of view V33, or in other words, has the function of irradiating the wide-angle illumination light L34 as low-angle illumination onto the camera field of view V33.

In the attachment 4 shown in FIG. 8D, a color filter 45 is attached to the window 414 for the wide-angle illumination unit 34. Therefore, the wide-angle illumination light L34 emitted from the wide-angle illumination unit 34 is irradiated onto the camera field of view V33 of the rear camera 33 through the color filter 45. This color filter 45 has the function of allowing only light of a specific color (specific wavelength) among the wide-angle illumination light L34 to pass through.

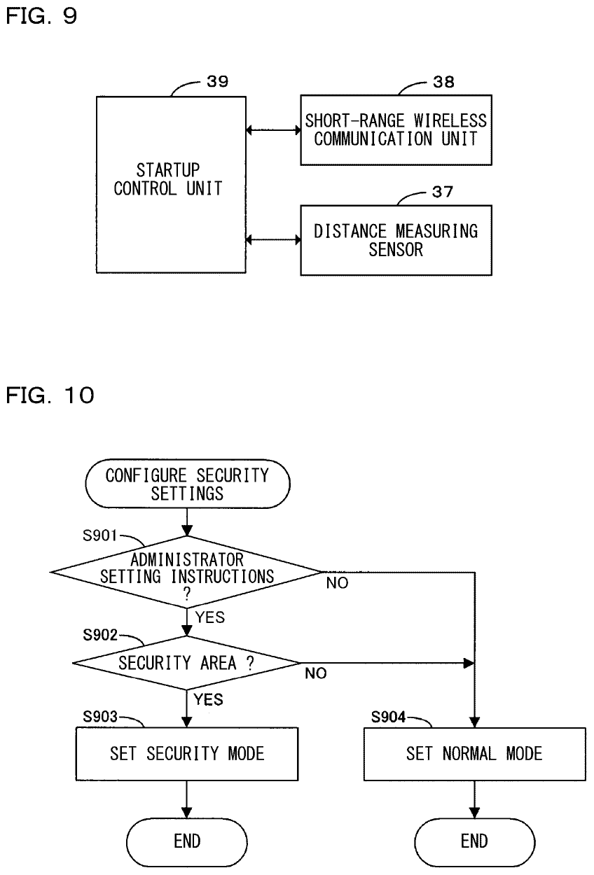

In this way, four types of attachments 4, for example, shown in FIG. 8A to FIG. 8E, can be detachably attached to the housing 11. In contrast, the portable information terminal 1 can determine the type of attachment 4 that is attached to the housing 11. FIG. 9 is a block diagram showing the electrical configuration of the portable information terminal that determines the type of attachment.

As shown in FIG. 9, the portable information terminal 1 has a short-range wireless communication unit 38 and a startup control unit 39. The attachment cover 41 of the attachment 4 has an identifier built in that identifies the type of the attachment 4, and the short-range wireless communication unit 38 reads the identifier of the attachment 4 via NFC (Near Field Communication) to determine the type of the attachment 4. Furthermore, the startup control unit 39 controls the activation of the short-range wireless communication unit 38 according to the distance measured by the distance measuring sensor 37.

That is, the startup control unit 39 detects the approach of the attachment 4 to the housing 11 based on the distance measured by the distance measuring sensor 37. When the measured distance of the distance measuring sensor 37 is longer than the communicable distance by NFC, the startup control unit 39 puts the short-range wireless communication unit 38 to sleep. On the other hand, when the measured distance of the distance measuring sensor 37 becomes less than or equal to the communicable distance by NFC, the startup control unit 39 determines that the attachment 4 has approached the housing 11 and activates the short-range wireless communication unit 38. Then, the activated short-range wireless communication unit 38 reads the identifier of the attachment 4 and determines the type of the attachment 4.

In the above-described embodiment, a volatile memory unit 61 (first memory unit) and a non-volatile memory unit 62 (second memory unit) are provided as a memory unit capable of storing captured images (photo image Ip, code image Ic) (FIG. 2A). Then, the volatile memory unit 61 is used for the decoding process among these. That is, the code image Ic generated by the rear camera 33 is stored in the volatile memory unit 61, and the decoder 86 (reading unit) performs the decoding process based on the stored code image Ic. Thus, the code C (image processing target) is captured using the rear camera 33 of the portable information terminal 1, and the decoding process is executed. In addition, a normal mode (first mode) and a security mode (second mode) are provided as modes for storing the code image Ic generated by the rear camera 33. The normal mode stores the code image Ic generated by the rear camera 33 in the non-volatile memory unit 62 (step S603 in FIG. 6D). The security mode deletes the code image Ic generated by the rear camera 33 from the volatile memory unit 61 without storing it in the non-volatile memory unit 62 (step S604 in FIG. 6D). In the security mode, instead of this operation, a step of forcibly deleting the code image Ic stored in the non-volatile memory unit 62 from the non-volatile memory unit 62 may be executed. With this configuration, by selecting the security mode, the code image Ic generated by the rear camera 33 is deleted, so there is no leakage to the outside. Thus, when using the rear camera 33 mounted on the portable information terminal 1 for capturing the code C, the external leakage of the code image Ic captured bythe rear camera 33 can be prevented.

Furthermore, a display 20 is further provided, and the service unit 88 (control unit) displays the code image Ic, which is stored in the volatile memory unit 61 and is the target of the decoding process of the decoder 86, on the display 20 (image view window 93) regardless of whether the normal mode of the security setting unit 74 (mode selection unit) is selected or the security mode is selected. With such a configuration, a user operating the portable information terminal 1 can perform tasks while visually recognizing the code image Ic, which is the target of the decoding process, on the display 20, thereby improving the user's operability.

Furthermore, the screenshot prohibition unit 76 (control unit) prohibits the screenshot of the display 20 displaying the code image Ic when selecting the security mode of the security setting unit 74, or stores the disabled or masked image of the screenshot of the display 20 displaying the code image Ic in the non-volatile memory unit 62 (FIG. 6E). With this configuration, it is possible to prevent the screenshot image from leaking to the outside.

Furthermore, a photo shooting processing unit 71 is provided that generates a photo image Ip using the rear camera 33 and stores it in the non-volatile memory unit 62. The control unit 5 controls the rear camera 33 via either a camera control public API 51 (public API) that generates the photo image Ip in response to a request from the photo shooting processing unit 71, or a camera control private API 52 (private API) that generates a code image Ic in response to a request from the code reading processing unit 72 (reading unit). In other words, in normal mode, both the control of the rear camera 33 via the camera control public API 51 and the control of the rear camera 33 via the camera control private API 52 are permitted. In security mode, while the control of the rear camera 33 via the camera control private API 52 is permitted, the control of the rear camera 33 via the camera control public API 51 is prohibited. In this configuration, the APIs (public API and private API) for photo shooting and decoding processing are separated, allowing for easy switching of security for photos taken by the rear camera 33.

In addition, a telephone communication unit 83 that performs communication via a telephone line is provided. The communication control unit 81 (control unit) permits voice calls via the telephone communication unit 83 with telephone terminals of registered telephone numbers when selecting the security mode of the security setting unit 74, while prohibiting voice calls via the telephone communication unit 83 with telephone terminals of unregistered telephone numbers. With this configuration, the range of telephone use can be restricted to prevent information from leaking externally.

Furthermore, the communication control unit 81 prohibits the recording of voice calls by the telephone communication unit 83 when selecting the security mode of the security setting unit 74. With this configuration, it is possible to prevent the recording of voice calls from leaking to the outside.

An internet communication unit 82 that performs communication via the internet is provided. The communication control unit 81 prohibits the connection to the internet by the internet communication unit 82 when selecting the security mode of the security setting unit 74. With this configuration, it is possible to prevent information leakage to the outside via the internet.

This embodiment can address the following issues. In other words, there is a need to easily perform reading of codes as described above and image processing such as OCR (Optical Character Recognition/Reader) using portable information terminals represented by smartphones. In response to this, by using the camera mounted on the portable information terminal for capturing images of the image processing target, it can meet such needs. In particular, by displaying the camera's field of view on the display unit of the smartphone, the user can confirm that the user is capturing the image processing target within the camera's field of view while performing operations.

However, there were cases where displaying the camera's field of view on the display unit impaired the user's operability. In other words, the display unit of the camera shows the user application screen used for user operations. This user application screen is provided with predetermined input items, and the results of image processing are input into the input item that has been focused on (in other words, selected) by the user. At this time, due to the display of the camera's field of view, the display on the display unit switches from the user application screen to the camera's field of view, which caused the user to lose sight of the input item the user was operating on.

In contrast, this embodiment allows the camera's field of view to be displayed while ensuring the user's operability with respect to the user application screen.

The portable information terminal according to this embodiment includes a camera that captures a workpiece to generate a captured image, an image processing unit that executes image processing based on the captured image, a service unit that sends the result of the image processing to a user application that has at least one input item and reflects the result of the image processing in the input item, and a display unit that displays the user application screen when the user application is executed. The service unit, during the execution of the user application, when the camera is activated to perform image processing, maintains the state in which the input item focused on (in other words, selected) as the input target in the user application screen is visually recognizable by the user, and displays an image view window showing at least a part of the camera's field of view along with the user application screen on the display unit.

The portable information terminal control method according to this embodiment includes a step of capturing a workpiece using a camera mounted on the portable information terminal to generate a captured image, a step of executing image processing based on the captured image, a step in which a service unit sends the result of the image processing to a user application that has at least one input item and reflects the result of the image processing in the input item, and a step in which a display unit displays the user application screen when the user application is executed. The service unit, during the execution of the user application, when the camera is activated to perform image processing, maintains the state in which the input item focused on (in other words, selected) as the input target in the user application screen is visible to the user, and displays an image view window showing at least a part of the camera's field of view along with the user application screen on the display unit.

In this embodiment, when the rear camera 33 (camera) is activated to perform the decoding process (image processing), an image view window 93 showing at least a part of the camera field of view V33 of the rear camera 33 is displayed on the display 20 (display unit) while maintaining a state in which the input item focused on as the input target among the input items of the user application screen 91 is visually recognizable by the user, along with the user application screen 91 (FIG. 3A). Thus, it becomes possible to display the camera field of view V33 of the rear camera 33 while ensuring the operability of the user regarding the user application screen 91.

Furthermore, the service unit 88 displays the image view window 93 in a semi-transparent manner over the user application screen 91, and the area of the user application screen 91 that overlaps with the image view window 93 is displayed semi-transparently. With this configuration, the user can visually recognize the user application screen 91 displayed semi-transparently through the image view window 93. In this way, it becomes possible to display the camera field of view V33 of the rear camera 33 while ensuring the operability of the user regarding the user application screen 91.

Furthermore, the service unit 88 increases the transparency of the image view window 93 as the saturation of the image displayed in the image view window 93 increases. In this configuration, the transparency of the image view window 93 (the degree to which the user application screen 91 is transparent to the image view window 93) can be optimized according to the saturation of the image view window 93. As a result, it becomes possible to display the camera field V33 of the rear camera 33 while ensuring the operability of the user regarding the user application screen 91.

A trigger button 23 is provided that generates a trigger to execute the decode process (image processing) in the decoder 86 (image processing unit). When the trigger button 23 is operated, the service unit 88 displays the image view window 93 on the display 20, and closes the image view window 93 on the display 20 after the completion of the decode process. With this configuration, the image view window 93 can be displayed at a timing corresponding to the operation of the trigger button 23.

Furthermore, the service unit 88 causes the decoder 86 to perform the decoding process after waiting for a predetermined period of time after the trigger button 23 is operated, and when the decoding process is completed, it closes the image view window 93 on the display 20. In this configuration, the decoding process is executed after waiting for a predetermined period of time from the operation of the trigger button 23. As a result, there is no situation where the image view window 93 closes simultaneously with the completion of the decoding process before the user can confirm the code C that is the target of the decoding process, allowing the user to reliably confirm the code C that is the target of the decoding process through the image view window 93.

Furthermore, the decoder 86 is capable of executing the step S505 (multiple code processing) in FIG. 6C, which performs decoding processing for each of the multiple codes C attached to the workpiece W, and the step S406 (single code processing) in FIG. 6B, which performs decoding processing for a single code C attached to the workpiece W. In this regard, the decoder 86 increases the size of the image view window 93 displayed on the display 20 during step S505 (multiple code processing) compared to the size of the image view window 93 displayed on the display 20 during step S406 (single code processing). With this configuration, it is possible to display the image view window 93 at an appropriate size according to the number of codes C subject to decoding processing.

Furthermore, the service unit 88 displays a part (target range J) of the code image Ic (captured image) in the image view window 93. With this configuration, a part (target range J) of the code image Ic can be displayed enlarged in the image view window 93. The service unit 88 displays only a part of the field of view V33 of the rear camera 33 in the image view window 93. The service unit 88 excludes the area other than the corresponding part of the field of view V33 of the rear camera 33 from the target of image processing. This is to avoid confusion for the user, as the user would not know which code the user has read by reading a code that is not visible in the image view window 93. As another example, the image sensor of the rear camera 33 partially outputs pixel signals from a part of the area, and the service unit 88 displays the captured image corresponding to that part of the area of the image sensor in the image view window 93. By narrowing the readout area from the image sensor, the processing can be speeded up.

A distance measuring sensor 37 is provided, which measures the distance to the workpiece W based on the result of detecting the distance measuring light L37 reflected by the workpiece W after irradiating the distance measuring light L37 onto the workpiece W. The service unit 88 displays the target range J of the code image Ic in the image view window 93 and changes the size of the target range J according to the distance detected by the distance measuring sensor 37 (steps S801 and S802 in FIG. 7A). With such a configuration, an appropriate target range J corresponding to the distance to the workpiece W can be displayed in the image view window 93.

Furthermore, an aimer light illumination unit 36 that irradiates the workpiece W with an aimer light L36, which is visible light, and a distance measuring sensor 37 that measures the distance to the workpiece W based on the result of detecting the distance measuring light L37 irradiated onto the workpiece W and reflected by the workpiece W are provided. The service unit 88 displays a target range J centered on a center Mj (target position) that is biased to a position corresponding to the irradiation position of the aimer light L36 from the center M33 (imaging center) of the code image Ic in the code image Ic in the image view window 93. At this time, the service unit 88 changes the center Mj of the target range J according to the distance detected by the distance measuring sensor 37 (FIG. 7B, FIG. 7C). With such a configuration, it is possible to execute the decoding process focusing on the range biased to the irradiation position of the aimer light L36, in other words, the existence range of the image of the code C to be decoded.

The distance measuring sensor 37 is provided to measure the distance to the workpiece W based on the result of detecting the distance measuring light L37 reflected by the workpiece W after irradiating the distance measuring light L37 onto the workpiece W. The service unit 88 calculates the depth of field of the rear camera 33 from the distance to the workpiece W measured by the distance measuring sensor 37 and displays it in the image view window 93 (step S804 in FIG. 7A, FIG. 7D). With this configuration, the user can confirm the suitability of the depth of field through the image view window 93.

Furthermore, the service unit 88 displays a warning in the image view window 93 when the depth of field is below the threshold. With this configuration, the user can confirm that the depth of field is inappropriate through the image view window 93.

Furthermore, this embodiment can address the following issues. In other words, there is a need to easily perform reading of codes as described above and image processing such as OCR (Optical Character Recognition/Reader) using portable information terminals represented by smartphones. In response to this, by using the camera mounted on the portable information terminal for imaging the image processing target, it can meet such needs.

Such image processing is operated by sequentially registering the results of image processing to a predetermined user application for use. Conventionally, since the user selected the image processing results to be registered in the user application, it required effort for the user's selection. In particular, there were cases where the user could not determine the necessity of registration to the user application, making such selection difficult for the user.

In contrast, this embodiment allows the user to easily confirm the necessity of registering the results of image processing using the camera of the portable information terminal to the user application.

The portable information terminal according to this embodiment includes a camera that captures a workpiece and generates a captured image, an image processing unit that performs image processing based on the captured image, at least one input item, and a service unit that sends the result of the image processing to a user application that reflects the result of the image processing in the input item and receives a response from the user application, and a display unit that displays an image view window showing the captured image. The user application determines the necessity of registration of the result of the image processing to the user application based on the result of the image processing received from the service unit, sends the determination result of the necessity of registration to the service unit, and the service unit displays an image view window on the display unit that overlays the information indicating the determination result received from the user application on the captured image.

The image processing result registration method according to this embodiment includes a step in which a camera captures a workpiece and generates a captured image, a step in which image processing is executed based on the captured image, and a user application that has at least one input item and reflects the result of the image processing in the input item, wherein a service unit sends the result of the image processing to the user application and receives a response from the user application, and a step in which an image view window showing the captured image is displayed on a display unit, and the user application determines the necessity of registering the result of the image processing to the user application based on the result of the image processing received from the service unit, sends the determination result of the necessity of registration to the service unit, and the service unit displays an image view window on the display unit that shows information indicating the determination result received from the user application overlaid on the captured image.

In this embodiment, the user application 87 determines the necessity of registration of the reading data Dc, which is the result of the decoding process received from the service unit 88, based on the reading data Dc, and sends the determination result of the necessity of registration to the service unit 88 (steps S102 to S103 in FIG. 5A). Then, the service unit 88 displays an image view window 93 on the display 20, which overlays the marks Ma and Mb (information) indicating the determination result received from the user application 87 onto the code image Ic (FIG. 5C). Therefore, the user can easily confirm the necessity of registration of the reading data Dc (image processing result) based on the marks Ma and Mb displayed in the image view window 93. In this way, it becomes possible for the user to easily confirm the necessity of registration of the result of the decoding process using the rear camera 33 of the portable information terminal 1 to the user application 87.

Furthermore, the user application 87 has data registration conditions 951 that include at least one condition related to the reading data Dc that requires registration to the user application 87, and determines the necessity of registration based on the data registration conditions 951 (step S202 in FIG. 5B, FIG. 5C). With such a configuration, the necessity of registration of the reading data Dc can be easily and automatically determined based on the data registration conditions 951.

Data registration condition 951 includes conditions related to the type of code C that is the target of the decoding process, the character string included in code C that is the target of the decoding process, the numerical values included in code C that is the target of the decoding process, and the position of code C that is the target of the decoding process. With such a configuration, it is possible to determine the necessity of registering the reading data Dc easily and automatically, which is the result of the decoding process, with appropriate conditions corresponding to code C that is the target of the decoding process.

Furthermore, the service unit 88 displays the image view window 93 on the display 20, in which the code C that is the target of the decoding process included in the code image Ic currently displayed in the image view window 93, which is identified by the mark Ma as requiring registration to the user application 87, based on the determination result received from the user application 87 (step S104 in FIG. 5A, FIG. 5C). With this configuration, the user can easily confirm that registration of the reading data Dc of the identified code C is necessary based on the image view window 93.

Furthermore, the service unit 88 displays an image view window 93 on the display 20 that distinguishes between the codes C that require registration, the codes C that do not require registration because they are already registered, and the codes C that are unregistered and do not require registration. With this configuration, the user can easily confirm the registration status and necessity of each code C, which is the target of the decoding process, based on the image view window 93.

Furthermore, when the decoder 86 receives a flick operation (registration operation) by the user while the image view window 93, in which the code C requiring registration is specified by the mark Ma, is displayed on the display 20, it registers the reading data Dc of the code C requiring registration (steps S105 to S106 in FIG. 5A). With this configuration, the user can easily register the reading data Dc of the code C requiring registration in the user application 87 by performing the flick operation.

Furthermore, this embodiment can address the following issues. In other words, there is a need to easily read codes using portable information terminals represented by smartphones. However, the cameras and lighting mounted on such portable information terminals are primarily intended for capturing photographs of people and landscapes, and are not necessarily suitable for reading codes. As a result, it took time for focusing and exposure, making it difficult to achieve rapid code reading.

This embodiment enables rapid reading of codes using the camera of a portable information terminal used for photography.

The portable information terminal according to this embodiment includes a housing having a first main surface provided with a display unit and a second main surface different from the first main surface, a camera that captures a field of view to generate a captured image with a variable focus position, a wide-angle illumination unit that irradiates wide-angle illumination light into the field of view of the camera, a narrow-angle illumination unit that irradiates narrow-angle illumination light into the field of view of the camera at an angle narrower than that of the wide-angle illumination light, an aimer light irradiation unit that irradiates visible light as aimer light onto a workpiece, a distance measuring sensor that measures the distance to the workpiece based on the result of detecting the distance measuring light irradiated onto the workpiece and reflected by the workpiece, a focus adjustment unit that adjusts the focus position of the camera according to the distance measured by the distance measuring sensor, a decoder that executes the decoding process of the code attached to the workpiece based on the captured image of the workpiece, and an imaging control unit that controls the conditions under which the camera captures images. The camera, wide-angle illumination unit, narrow-angle illumination unit, aimer light irradiation unit, and distance measuring sensor are provided on the second main surface of the housing, and the imaging control unit generates a captured image for photography by causing the camera to capture images while irradiating wide-angle illumination light from the wide-angle illumination unit for photography, while for the decoding process, the imaging control unit causes the aimer light irradiation unit to irradiate the aimer light onto the workpiece, and while irradiating narrow-angle illumination light from the narrow-angle illumination unit, the imaging control unit causes the focus adjustment unit to adjust the focus position of the camera based on the distance measured by the distance measuring sensor to generate a captured image for decoding processing in the camera.

In this embodiment, a housing 11 having a front surface 12 (first main surface) and a rear surface 13 (second main surface) is provided, with a display 20 (display unit) arranged on the front surface 12 and a rear camera 33 and a wide-angle illumination unit 34 arranged on the rear surface 13. The wide-angle illumination unit 34 irradiates wide-angle illumination light L34 into the camera field V33 of the rear camera 33 while the rear camera 33 captures the camera field V33, thereby generating a photo image Ip (captured image) (photo shooting). Furthermore, a narrow-angle illumination unit 35, an aimer light illumination unit 36, and a distance measuring sensor 37 are provided on the rear surface 13. The narrow-angle illumination unit 35 irradiates narrow-angle illumination light L35 with a narrower light distribution angle than the wide-angle illumination light L34 into the camera field V33 of the rear camera 33, the aimer light illumination unit 36 irradiates aimer light L36, which is visible light, onto the workpiece W, and the distance measuring sensor 37 irradiates distance measuring light L37 onto the workpiece W and measures the distance to the workpiece W based on the result of detecting the distance measuring light L37 reflected by the workpiece W. In the decoding process, the following operations are performed. That is, the user holds the portable information terminal 1 over the workpiece W so that the aimer light L36 from the aimer light illumination unit 36 is irradiated onto the workpiece W. As a result, the distance measuring light L37 from the distance measuring sensor 37 and narrow-angle illumination light L35 from narrow-angle illumination unit are irradiated onto workpiece W. Consequently, focus position of rear camera is rapidly adjusted according to measured distance by distance measuring sensor and captured with relatively short exposure time of narrow angle illuminating lights thus generating code image Ic. Then decoder performs decoding process based on code image Ic thus rapid reading of code C made possible using rear camera of portable information terminal used for photo shooting. It should be noted that rolling shutter method more prone to shake compared to global shutter method. To suppress influence of shake it necessary shorten exposure time of rear camera here since narrow angle illuminating lights have higher illuminance than wide angle illuminating lights exposure time can be shortened by using them.

Furthermore, the aimer light L36 and the distance measuring light L37 are included in the camera field of view V33 of the rear camera 33, and are also included in the range where the narrow-angle illumination light L35 is emitted. The positions of the aimer light L36 and the distance measuring light L37 on the workpiece W are included in the depth of field of the rear camera 33, whose focus position is adjusted by the non-public API control unit 56 (focus adjustment unit). In this configuration, as the user holds the portable information terminal 1 over the workpiece W so that the aimer light L36 is emitted from the aimer light illumination unit 36 to the workpiece W, the distance measuring light L37 is emitted within the irradiation range of the narrow-angle illumination light L35 on the workpiece W, allowing the focus of the rear camera 33 to be adjusted to the irradiation range based on the distance measured by the distance measuring sensor 37. As a result, the rear camera 33 can generate the code image Ic with the focus set on the code C illuminated by the narrow-angle illumination light L35.

Furthermore, the optical axes of the aimer light L36, the distance measuring light L37, the camera field of view V33 of the rear camera 33, and the narrow-angle illumination light L35 are parallel to each other. With this configuration, regardless of the distance to the workpiece W, the positional relationship of the aimer light L36, the distance measuring light L37, the camera field of view V33 of the rear camera 33, and the narrow-angle illumination light L35 can be uniformly maintained.

The distance K35 between the optical axis of the narrow-angle illumination light L35 and the rear camera 33 is less than or equal to the distance K34 between the optical axis of the wide-angle illumination unit 34 and the optical axis of the rear camera 33. In this configuration, the narrow-angle illumination unit 35 is arranged in close proximity to the rear camera 33, allowing the narrow-angle illumination light L35 to accurately illuminate the code C within the camera field of view V33 of the rear camera 33.

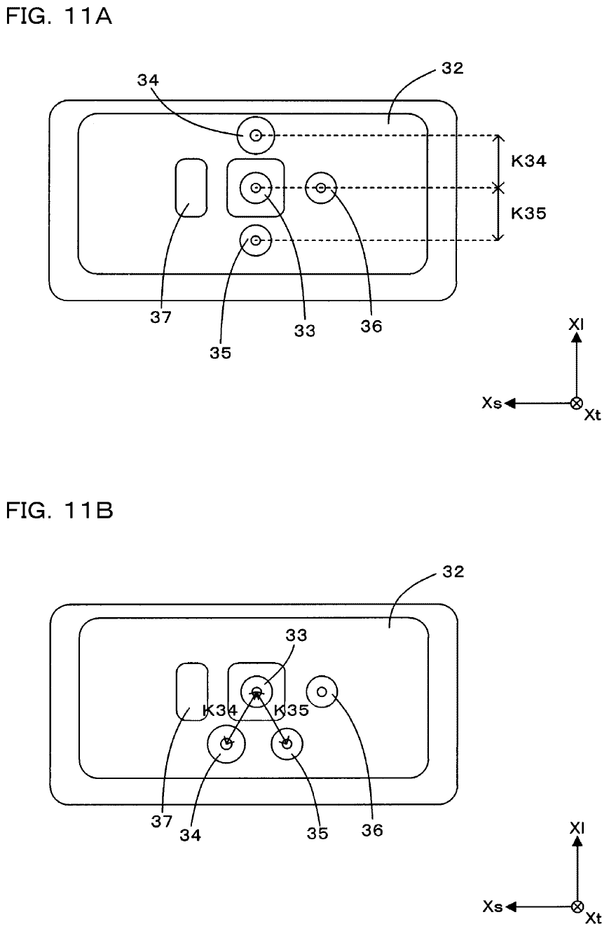

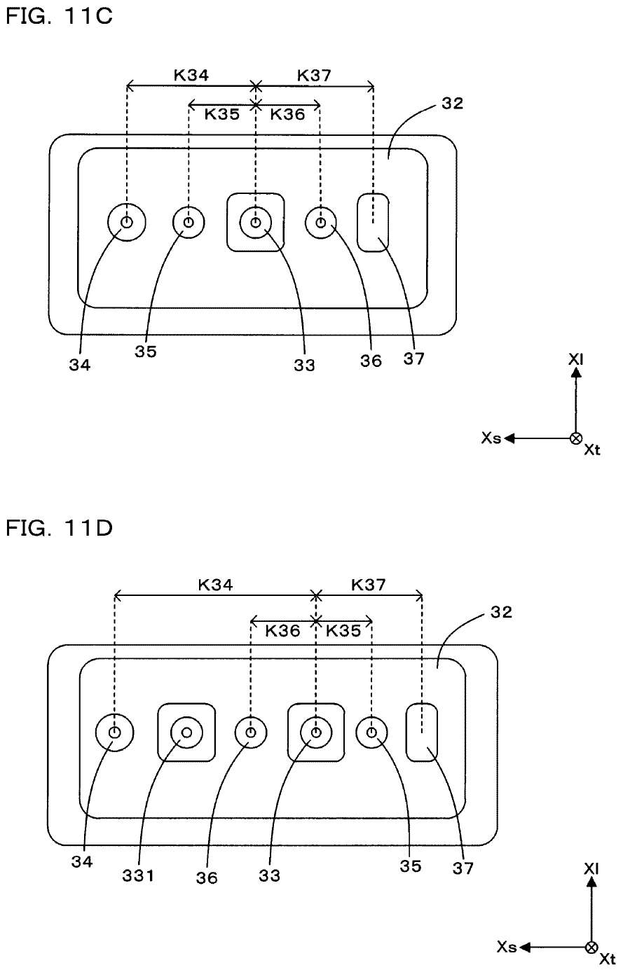

Furthermore, the rear camera 33 is arranged in a line with any two of the narrow-angle illumination unit 35, the aimer light illumination unit 36, and the distance measuring sensor 37 (FIG. 1E, FIGS. 11A to 11D). With such a configuration, the narrow-angle illumination light L35, the aimer light L36, and the distance measuring light L37 can be brought close together and accommodated within the camera field of view V33 of the rear camera 33.

An attachment 4 for a rear camera 33 that is detachably attached to the housing 11 is provided. The attachment 4 has a polarizing plate 423 (optical component) that adjusts the characteristics of light incident on the rear camera 33 while being attached to the housing 11 and facing the rear camera 33. With this configuration, imaging by the rear camera 33 can be performed using an appropriate polarizing plate 423 according to the type of code C.

An attachment 4 of a narrow-angle illumination unit 35, which is detachably attached to the housing 11, is provided. The attachment 4 has a polarizing plate 425 (optical component) that adjusts the characteristics of the narrow-angle illumination light L35 emitted from the narrow-angle illumination unit 35, facing the narrow-angle illumination unit 35 while being attached to the housing 11. With such a configuration, the narrow-angle illumination light L35 can be emitted using an appropriate polarizing plate 425 according to the type of code C and the like.

Furthermore, a short-range wireless communication unit 38 (communication unit) that performs short-range wireless communication and a startup control unit 39 that controls the sleep and activation of the short-range wireless communication unit 38 are provided. The attachment 4 is equipped with an identifier that identifies the attachment 4, and the startup control unit 39 determines whether the attachment 4 is attached to the housing 11 based on the distance detected by the distance measuring sensor 37. Moreover, when the startup control unit 39 determines that the attachment 4 is not attached, it puts the short-range wireless communication unit 38 to sleep, while when it determines that the attachment 4 is attached, it activates the short-range wireless communication unit 38. Then, when the short-range wireless communication unit 38 is activated, it recognizes the identifier of the attachment 4 by the short-range wireless communication unit 38. With this configuration, the identifier of the attachment 4 attached to the housing 11 can be recognized by the short-range wireless communication of the short-range wireless communication unit 38. Furthermore, based on the distance detected by the distance measuring sensor 37, the short-range wireless communication unit 38 can be activated to recognize the identifier only when the attachment 4 is attached to the housing 11, which makes it possible to reduce the power consumption of the short-range wireless communication unit 38.

The decoder 86 changes the execution mode of the decoding process for the code image Ic according to the distance detected by the distance measuring sensor 37 (FIG. 7A). This allows the decoding process for the code image Ic to be executed in an appropriate execution mode according to the distance to the workpiece W.

For example, the decoder 86 performs decoding processing on the result of executing binning, which combines adjacent pixels into one pixel of a predetermined size, on the code image Ic. At this time, the decoder 86 changes the size in the binning according to the distance detected by the distance measuring sensor 37 (step S806 in FIG. 7A). With such a configuration, binning of the code image Ic can be performed with an appropriate size according to the distance to the workpiece W.

The decoder 86 executes the decoding process for the target range J having a center Mj (target position) that is biased from the center M33 (imaging center) of the code image Ic to a position corresponding to the irradiation position of the aimer light L36 among the code images Ic. At this time, the service unit 88 changes the target range J according to the distance detected by the distance measuring sensor 37 (step S802 in FIG. 7A). With this configuration, the decoding process can be executed focusing on the range biased from the irradiation position of the aimer light L36, in other words, the existence range of the image of the code image Ic.

The decoder 86 performs decoding process on the target range J of the code image Ic. At this time, the service unit 88 changes the size of the target range J according to the distance detected by the distance measuring sensor 37 (step S802 in FIG. 7A). With this configuration, the decoding process can be performed focusing on the target range J according to the distance to the workpiece W, in other words, the existence range of the code image Ic.

A trigger button 23 is provided to generate a trigger for starting the generation of the code image Ic by the rear camera 33 and the execution of the decoding process on the code image Ic in the service unit 88 (imaging control unit). The housing 11 has a shape extending in the longitudinal direction Xl, and has a right side surface 14 (side surface) that connects the front surface 12 (first main surface) and the rear surface 13 (second main surface) and extends along the longitudinal direction Xl. The right side surface 14 has a recessed portion 141 that is recessed inward between the front surface 12 and the rear surface 13. The trigger button 23 has a base portion 231 that is arranged in the recessed portion 141 and extends in the longitudinal direction, and a protrusion 232 that protrudes outward from the right side surface 14 from the base portion 231. With this configuration, the user can visually or tactilely recognize the protrusion 232 of the trigger button 23 that protrudes from the recessed portion 141 and can reliably operate the trigger button 23.

The trigger button 23 is biased upward from the center M11 of the housing 11 in the longitudinal direction (FIG. 1C). In this configuration, since the trigger button 23 is offset from the center M11 of the housing 11, which is easy for the user to grip, it can suppress the user from accidentally operating the trigger button 23 when picking up the portable information terminal 1. Moreover, during reading, since the user's thumb and index finger tend to be positioned on the upper side of the housing 11, it is easy to operate the trigger button 23 even when the portable information terminal 1 is held over the code C in a difficult-to-read location.

This disclosure is not limited to the above embodiments, and various modifications can be made to the aforementioned as long as they do not deviate from the spirit thereof. For example, the method for setting the security mode may be changed as shown in FIG. 10. FIG. 10 is a flowchart showing a modified example of the method for setting the security mode. In the modified example of FIG. 10, the security setting unit 74 (FIG. 2A) determines whether the administrator has performed an operation to instruct the setting of the security mode on the administrator setting screen (step S901). If there is no instruction for setting the security mode (in the case of “NO” in step S901), the security setting unit 74 sets the normal mode in step S904 (that is, does not set the security mode).

On the other hand, if there is a setting instruction for the security mode (in the case of “YES” in step S901), the security setting unit 74 determines whether the portable information terminal 1 is within a predetermined security area (step S902). Specifically, the security setting unit 74 acquires the position information of the portable information terminal 1 calculated by the position information calculation unit 78 and determines whether the position indicated by the position information of the portable information terminal 1 is included in the security area. If the position of the portable information terminal 1 is not included in the security area (in the case of “NO” in step S902), the security setting unit 74 sets the normal mode in step S904. On the other hand, if the position of the portable information terminal 1 is included in the security area (in the case of “YES” in step S902), the security setting unit 74 sets the security mode in step S903.

In this modified example, the mode selection signal generated by the security setting unit 74 indicates which of the normal mode and the security mode is selected based on the settings by the administrator authority and the position information of the portable information terminal 1. In such a configuration, for example, if the position information indicates a position within the security area, the security mode is selected, and if the position information indicates a position outside the security area, the normal mode is selected, allowing for such operations. In the above embodiments and modified examples, two modes, the normal mode and the security mode, have been described, but this is not limited to these. That is, the security mode may include multiple security modes according to the security level, as shown in Table 1 below (1 to 4 in the table below), but is not limited to the combinations in Table 1.

TABLE 1

| | Normal | Security | Security | Security | Security |
|---|---|---|---|---|---|
| | Mode | Mode 1 | Mode 2 | Mode 3 | Mode 4 |
| Storage of photo image | ∘ | x | x | x | x |
| Ip in non-volatile | | | | | |
| memory unit 62 | | | | | |
| Storage of code image Ic | ∘ | ∘ | x | x | x |
| in non-volatile memory | | | | | |
| unit 62 | | | | | |
| Voice Call Recording | ∘ | ∘ | ∘ | x | x |
| Internet connection | ∘ | ∘ | ∘ | ∘ | x |

Furthermore, the layout of the rear camera unit 32 may be appropriately changed. FIGS. 11A to 11D are rear views showing modified examples of the layout in the rear camera unit. In the example of FIG. 11A, in the short side direction Xs, the rear camera 33 is arranged between the aimer light illumination unit 36 and the distance measuring sensor 37, and in the long side direction Xl, the rear camera 33 is arranged between the wide-angle illumination unit 34 and the narrow-angle illumination unit 35. Furthermore, the distance K35 between the rear camera 33 and the narrow-angle illumination unit 35 is less than or equal to the distance K34 between the rear camera 33 and the wide-angle illumination unit 34.

In the example of FIG. 11B, in the short-side direction Xs, the rear camera 33 is arranged between the aimer light illumination unit 36 and the distance measuring sensor 37. The wide-angle illumination unit 34 and the narrow-angle illumination unit 35 are arranged below the rear camera 33. In the short-side direction Xs, the narrow-angle illumination unit 35 is arranged on one side of the rear camera 33, and the wide-angle illumination unit 34 is arranged on the other side of the rear camera 33. Furthermore, the distance K35 between the rear camera 33 and the narrow-angle illumination unit 35 is less than or equal to the distance K34 between the rear camera 33 and the wide-angle illumination unit 34.

In the example of FIG. 11C, in the short-side direction Xs, the wide-angle illumination unit 34, the narrow-angle illumination unit 35, the rear camera 33, the aimer light illumination unit 36, and the distance measuring sensor 37 are arranged in this order. That is, the narrow-angle illumination unit 35 is arranged between the rear camera 33 and the wide-angle illumination unit 34, and the aimer light illumination unit 36 is arranged between the rear camera 33 and the distance measuring sensor 37. Furthermore, the distance K35 between the rear camera 33 and the narrow-angle illumination unit 35 is less than or equal to the distance K34 between the rear camera 33 and the wide-angle illumination unit 34, and the distance K36 between the rear camera 33 and the aimer light illumination unit 36 is less than or equal to the distance K37 between the rear camera 33 and the distance measuring sensor 37.

In the example of FIG. 11D, in the short-side direction Xs, the wide-angle illumination unit 34, the rear camera 331, the aimer light illumination unit 36, the rear camera 33, the narrow-angle illumination unit 35, and the distance measuring sensor 37 are arranged in this order. That is, the aimer light illumination unit 36 is arranged between the rear camera 33 and the wide-angle illumination unit 34, and the rear camera 331 is further arranged between the aimer light illumination unit 36 and the wide-angle illumination unit 34. In addition, the narrow-angle illumination unit 35 is arranged between the rear camera 33 and the distance measuring sensor 37. The distance K35 between the rear camera 33 and the narrow-angle illumination unit 35 is less than or equal to the distance K34 between the rear camera 33 and the wide-angle illumination unit 34, and is also less than or equal to the distance K37 between the rear camera 33 and the distance measuring sensor 37. The distance K36 between the rear camera 33 and the aimer light illumination unit 36 is less than or equal to the distance K34 between the rear camera 33 and the wide-angle illumination unit 34.

The structural differences between the rear camera 33 and the rear camera 331 can be variously assumed. For example, the rear camera 331 may be configured to have a longer imaging distance than the rear camera 33. Alternatively, the rear camera 331 may be configured to have a wider field of view angle than the field of view angle of the rear camera 33.

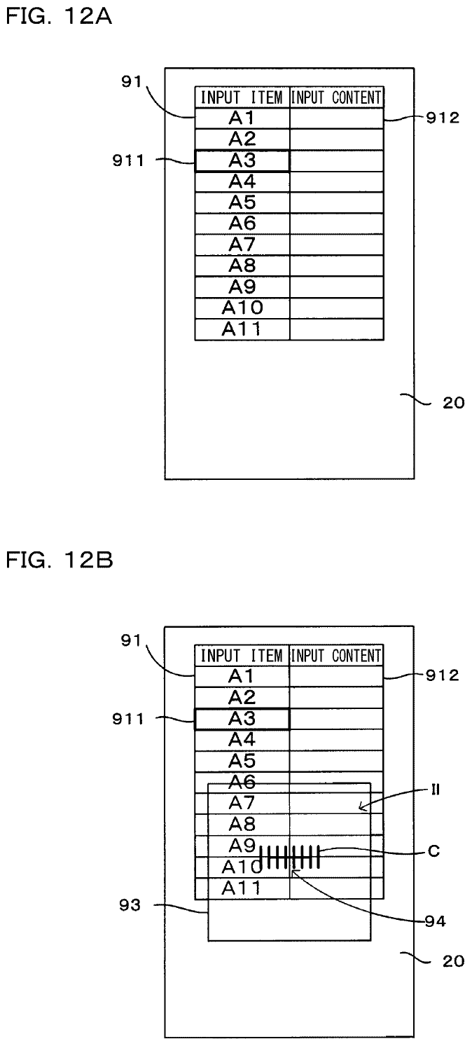

Furthermore, the manner of displaying the image view window 93 along with the user application screen 91 can be appropriately changed. FIGS. 12A and 12B are diagrams showing a first modified example of the display manner of the user application screen and the image view window. FIG. 12A shows the display of the display 20 before the image view window 93 is displayed, and FIG. 12B shows the display of the display 20 after the image view window 93 is displayed. In this first modified example, the service unit 88 acquires position information indicating the position of the input item A3 that is focused by the user's selection from the user application 87. Then, the service unit 88 displays the image view window 93 in a range outside the position of the focused input item A3 indicated by the position information on the display 20.

That is, the service unit 88 receives the position information of the input item A3, which is focused as the input target, from the user application 87 on the user application screen 91. Then, the service unit 88 displays the image view window 93 at a position that does not overlap with the focused input item A3 on the user application screen based on the position information (FIG. 12B). In this configuration, the image view window 93 is displayed so as not to overlap with the focused input item A3 on the user application screen 91, allowing the user to visually recognize the input item A3. Thus, it becomes possible to display the camera field of view V33 of the rear camera 33 while ensuring the user's operability with respect to the user application screen 91.

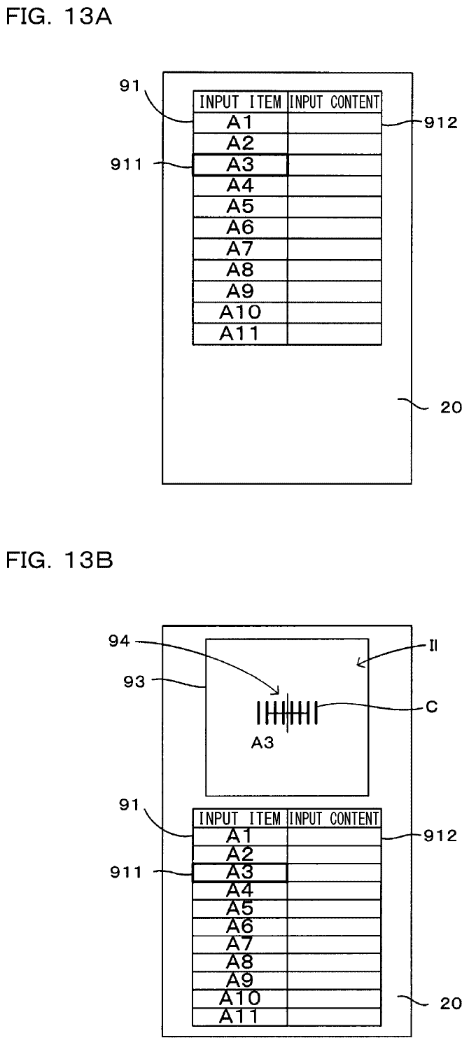

Alternatively, the image view window 93 can also be displayed in a display area specified by the user. FIGS. 13A and 13B are diagrams showing a second modified example of the display mode between the user application screen and the image view window. FIG. 13A shows the display of the display 20 before the image view window 93 is displayed, and FIG. 13B shows the display of the display 20 after the image view window 93 is displayed.

In this second modified example, the user can specify the display area of the image view window 93 on the display 20 by operating the display 20. This specification of the display area can be performed by setting the display area to the service unit 88 through the operation of the display 20, or by executing a predetermined operation (double tap or long touch) at the position on the display 20 that the user wants to specify as the display area. When the service unit 88 receives this specification of the display area, it displays the image view window 93 in the specified display area on the display 20, and displays the user application screen 91 in the area outside the specified display area (FIG. 13B). FIG. 13B shows the case where the upper part of the display 20 is specified as the display area.

That is, the service unit 88 accepts the specification of the display area of the image view window 93 on the display 20 and displays the user application screen 91 outside the display area of the image view window 93 on the display 20. In this configuration, the position of the image view window 93 is predetermined, and when displaying the image view window 93, the user application screen 91 is displayed outside of it, allowing the user to visually recognize the focused input item A3. In this way, it becomes possible to display the camera field of view V33 of the rear camera 33 while ensuring the user's operability with respect to the user application screen 91.

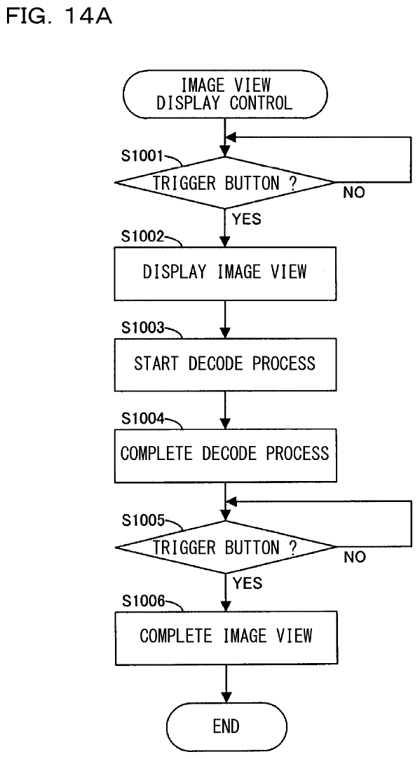

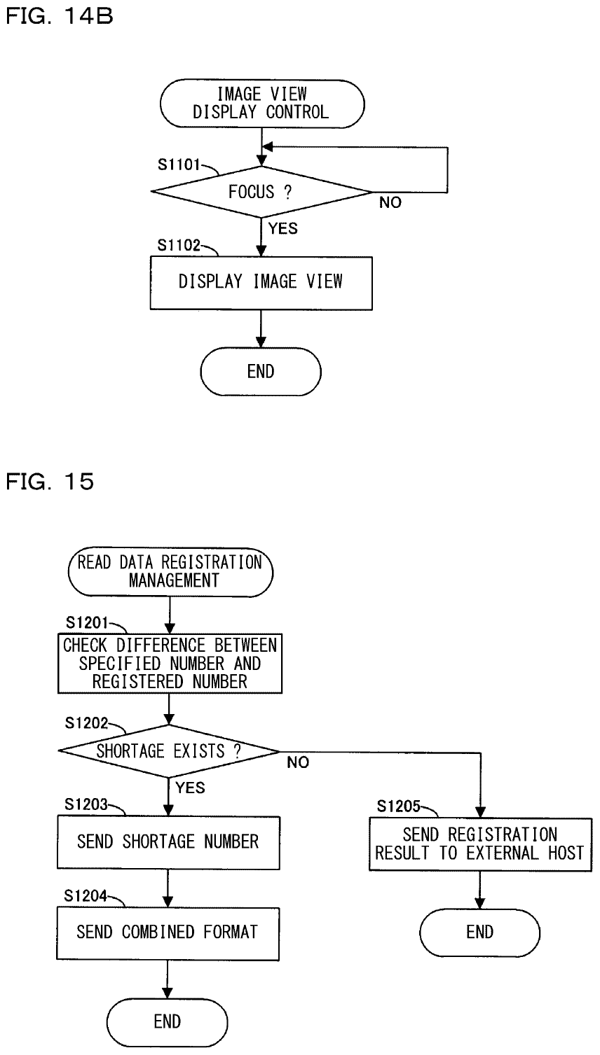

Furthermore, the control of the display period of the image view window 93 may be changed as appropriate. FIG. 14A is a flowchart showing a first modified example of the display control of the image view window. The service unit 88 confirms that the trigger button 23 has been pressed (“YES” in step S1001), displays the image view window 93 on the display 20 as described above (step S1002), and starts the decoding process in the decoder 86 (step S1003). Then, when the decoder 86 completes the decoding process (step S1004), the service unit 88 monitors whether the trigger button 23 has been pressed again (step S1005). When it confirms that the trigger button 23 has been pressed again (“YES” in step S1005), the service unit 88 ends the display of the image view window 93 (step S1006).

That is, the service unit 88 executes the decoding process (image processing) in the decoder 86 (image processing unit) when the trigger button 23 is operated, and when the trigger button 23 is operated again after the completion of the decoding process, it closes the image view window 93 on the display 20. In this configuration, the image view window 93 displayed by the operation of the trigger button 23 is continuously displayed until the trigger button 23 is operated again. In other words, there is no situation where the image view window 93 closes simultaneously with the completion of the decoding process before the user has time to confirm the code C, which is the target of the decoding process, and the user can reliably confirm the code C, which is the target of the decoding process, through the image view window 93.

FIG. 14B is a flowchart showing a second modified example of display control of the image view window. In this second modified example, when the user application 87 focuses on the input item by a designated operation on the user's display 20, it notifies the service unit 88 of the focus of the input item. Then, when the service unit 88 receives the notification of the focus of the input item (“YES” in step S1101), it displays the image view window 93 on the display 20 (step S1102).

That is, the user application 87 notifies the service unit 88 that the input item has been specified via the display 20, and the service unit 88, upon receiving the notification from the user application 87, displays the image view window 93 on the display 20. With such a configuration, the user can quickly display the image view window 93 at the timing when the user wants to perform an operation related to the decoding process (that is, the timing when the input item is specified).

Furthermore, the registration management of the reading data Dc by the user application 87 may be configured as shown in FIG. 15. FIG. 15 is a flowchart showing an example of the registration management of the reading data by the user application. In step S1201, the user application 87 checks the difference between the number of registered reading data Dc (number of registrations) registered in the data management table 95 and the specified number. Then, in step S1202, the user application 87 determines whether there is a shortage number of registrations against the specified number (in other words, it determines whether the number obtained by subtracting the number of registrations from the specified number is one or more).

If a shortage exists (when “YES” in step S1202), the user application 87 sends the corresponding shortage to the service unit 88 (step S1203), and the service unit 88 displays the shortage received from the user application 87 on the display 20 (for example, the image view window 93). Furthermore, the combination format for sending multiple reading data Dc to the user application 87 later is sent from the user application 87 to the service unit 88 (step S1204). Not limited to this, the user may define the format in the configuration file of the terminal prepared by the user. This combination format indicates, for example, that multiple reading data Dc are combined by separating them with commas. Therefore, when the service unit 88 confirms the registration instruction operation in the multiple code reading mode of FIG. 5A (step S105), it combines the multiple reading data Dc subject to the registration instruction operation according to the combination format and sends it to the user application 87. If no shortage exists (when “NO” in step S1202), the user application 87 sends the specified number of reading data Dc to the external host computer (step S1205).

That is, the user application 87 specifies a combination format to the service unit based on the registration status of the user application 87 and the result of the reading data Dc sent from the service unit 88, which will be used to combine the data sent in subsequent registration operations (steps S1201, S1204). Then, the service unit 88 combines the reading data Dc, which is the result of the decoding process of multiple codes C included in the image view window 93, based on the specified combination format and sends it to the user application 87. In this configuration, the reading data Dc, which is the result of the decoding process of multiple codes C, can be combined in an appropriate combination format and sent to the user application 87 in a consolidated manner.

Furthermore, the user application 87 sends the accumulated number of registered reading data Dc (the result of the decoding process) sent from the service unit 88 when it reaches the specified number (when “NO” in step S1202) to the external host (in step S1205). With this configuration, the frequency of sending from the user application 87 to the external host can be suppressed, thereby reducing the load associated with these.

Furthermore, the user application 87 sends the shortage number up to the specified number to the service unit 88 based on the number of registered reading data Dc and the specified number (step S1203), and the service unit 88 displays the shortage number on the display 20. This configuration allows the user to easily check the shortage number via the display 20. Additionally, not only when sent from the user application 87, the service unit 88 can also recognize the registration progress status of the image processing results based on the response from the user application 87. If the service unit 88 has previously obtained the information of the specified number, it can also recognize the shortage number. By displaying the registration progress status on the display 20, the user can easily grasp the current number of reading data and the shortage number. The service unit 88 may obtain the judgment conditions regarding the timing for sending the registered image processing results from the user application 87 to the external host. The judgment conditions may include, for example, the number of reading data registered in the user application (when 10 are registered), the code type (when a specific code type is read), user operations (when double-tapped), and so on, but are not limited to these. The judgment conditions may be defined not only in the format information sent from the user application 87 to the service unit 88 but also in the configuration file of the terminal prepared by the user. When the judgment conditions are satisfied, the service unit 88 sends an instruction to the user application 87 to send the registered image processing results from the user application 87 to external host. This allows the user application side to eliminate the trouble of implementing the logic to determine the timing for sending to external host.

Furthermore, the specific manner of the administrator's security mode setting instruction for the security setting unit 74 can be changed as appropriate. In other words, in the above-mentioned embodiment, the security setting unit 74 displays the administrator setting screen on the display 20 and accepts the administrator's security mode setting instruction based on the operation on the administrator setting screen by the administrator. In contrast, in the modified example described here, the security setting unit 74 is equipped with a communication function with an external management server used by the administrator. The security setting unit 74 receives a mode selection signal from the management server.

That is, the security setting unit 74 (communication unit) has a communication function that receives a mode selection signal. Then, the security setting unit 74 selects either the security mode or the normal mode based on the mode selection signal received by the communication function. Here, the mode selection signal indicates which of the security mode and the normal mode is selected based on the setting by administrator authority. With such a configuration, it is possible to prevent users other than the administrator and finders from switching between the security mode and the normal mode.

Furthermore, in the above example, during code reading, the narrow-angle illumination unit 35 irradiates the narrow-angle illumination light L35 in the camera field of view V33, and the rear camera 33 captures the code C within the camera field of view V33 to obtain the code image Ic. However, the wide-angle illumination unit 34 may also be used during code reading. For example, it is anticipated that overexposure may occur in the code image Ic captured using the narrow-angle illumination light L35, resulting in a failure to read the reading data Dc during the decoding process of the code image Ic. In such a case, the illumination unit used may be switched from the narrow-angle illumination unit 35 to the wide-angle illumination unit 34, and the code reading may be re-executed. Specifically, the wide-angle illumination unit 34 irradiates the wide-angle illumination light L34 in the camera field of view V33, and the rear camera 33 captures the code C within the camera field of view V33 to obtain the code image Ic. Then, the decoder 86 executes the decoding process on the code image Ic to obtain the reading data Dc.

That is, the service unit 88 (imaging control unit) adjusts the focus position of the rear camera 33 by the non-public API control unit 56 (focus adjustment unit) while irradiating the narrow-angle illumination unit 35 with narrow-angle illumination light L35, and if the decoding process for the generated code image Ic captured by the rear camera 33 fails, it executes the decoding process for the generated code image Ic by adjusting the focus position of the rear camera 33 by the non-public API control unit 56 (focus adjustment unit) while irradiating the wide-angle illumination unit 34 with wide-angle illumination light L34. In such a configuration, if the decoding process using the narrow-angle illumination light L35 fails due to overexposure or the like, there is a possibility of success in the decoding process using the wide-angle illumination light L34.

In the example of FIG. 2A, in order to prohibit photo shooting in security mode, a camera control public API 51 and a camera control private API 52 are provided, and these are used selectively. However, it may also be configured to prepare only the camera control private API 52 and allow access to the camera module 3 only from specific applications, such as the code reading processing unit 72, during security mode.

Furthermore, as a specific example of image processing, it is not limited to the above-mentioned decoding process, but also includes other image processing such as OCR.

This invention is applicable to the technology for reading codes attached to a workpiece in general.

What is claimed is:

1. A portable information terminal comprising:
a camera that captures a workpiece and generates a captured image,
a reading unit that executes image processing based on the captured image to acquire information contained in the workpiece,
a first memory unit that is a volatile memory unit and temporarily stores the captured image,
a second memory unit that is a non-volatile memory unit and stores settings of the image processing and is capable of storing the captured image,
a control unit that causes the camera to generate the captured image and store the captured image in the first memory unit, and causes the reading unit to execute the image processing based on the captured image in the first memory,
a mode selection unit that selects any of a plurality of modes including a first mode where the captured image is stored in the second memory unit and a second mode where the captured image is deleted from the first memory unit without the captured image being not stored in the second memory unit or the captured image is forcibly deleted from the second memory unit after being stored in the second memory.

2. The portable information terminal according to claim 1, further comprising:
a communication unit that receives a mode selection signal, wherein
the mode selection unit selects one of the plurality of modes based on the mode selection signal received via the communication unit, and
the mode selection signal indicates which of the plurality of modes is selected based on settings by an administrator authority.

3. The portable information terminal according to claim 2, wherein
the mode selection signal indicates which of the plurality of modes is selected based on the setting by the administrator authority and the position information of the portable information terminal.

4. The portable information terminal according to claim 1, further comprising:
a display unit, wherein
the control unit displays, on the display unit, the captured image stored in the first memory unit and subject to the image processing by the reading unit, regardless of whether the first mode or the second mode is selected by the mode selection unit.

5. The portable information terminal according to claim 4, wherein
the control unit prohibits a screenshot of the display unit displaying the captured image when the second mode is selected, or stores an image that is either disabled or masked of the screenshot of the display unit in the second memory unit.

6. The portable information terminal according to claim 1, further comprising:
a photo shooting processing unit that generates the captured image by the camera and stores the captured image in the second memory unit, wherein
the control unit controls the camera via either a public API that controls the camera to generate the captured image in response to a request from the photo shooting processing unit, or a private API that controls the camera to generate the captured image in response to a request from the reading unit,
in the first mode, both the control of the camera via the public API and the control of the camera via the private API are permitted, and
in the second mode, while the control of the camera via the private API is permitted, the control of the camera via the public API is prohibited.

7. The portable information terminal according to claim 1, further comprising:
a telephone communication unit that performs communication via a communication line, wherein
in the second mode, the control unit allows voice calls via the telephone communication unit with telephone terminals of registered telephone numbers, while prohibiting the voice calls via the telephone communication unit with telephone terminals of unregistered telephone numbers.

8. The portable information terminal according to claim 7, wherein
the control unit prohibits recording of voice calls by the telephone communication unit in the second mode.

9. The portable information terminal according to claim 1, further comprising:
an internet communication unit that performs communication via internet, wherein
the control unit prohibits connection to the internet by the internet communication unit in the second mode.

10. The portable information terminal according to claim 1, wherein
the plurality of modes includes a third mode where the captured image, for which image processing is executed, is stored in the second memory unit, while a photo image generated by the camera is deleted from the first memory unit without being stored in the second memory unit, or the photo image is forcibly deleted from the second memory unit after being stored in the second memory unit.

11. An image management method for managing a first memory unit or a second memory unit of a captured image generated by a camera that captures a workpiece, comprising:
a step of selecting any of a plurality of modes including a first mode where the captured image generated by the camera is stored in the second memory unit, and a second mode where the captured image is deleted from the first memory unit without being stored in the second memory unit, or the captured image is forcibly deleted from the second memory unit after being stored in the second memory unit; and
a step of controlling the camera to generate the captured image and storing the captured image in the first memory unit, and executing image processing based on the captured image in the first memory unit to acquire information included in the workpiece,
wherein
the first memory unit is a volatile memory unit that temporarily stores the captured image, and
the second memory unit is a non-volatile memory unit that is capable of storing the captured image and stores settings of the image processing.
